(19) United States
(12) Patent Application Publication
(10) Pub. No.: US 2009/0320050 A1
(43) Pub. Date: Dec. 24, 2009

(54) Mobile Network Community Platform Desktop API

(75) Inventors: Michael Pousti, San Diego, CA (US); Andrew Ballester, San Diego, CA (US); Scott McHugh, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: SMS.AC, San Diego, CA (US)

(21) Appl. No.: 12/404,164

(22) Filed: Mar. 13, 2009

Related U.S. Application Data
(63) Continuation-in-part of application No. 12/056,090, filed on Mar. 26, 2008.
(60) Provisional application No. 61/036,430, filed on Mar. 13, 2008.
(60) Provisional application No. 60/956,626, filed on Aug. 17, 2007.

(51) Int. Cl. G06F 9/44

(52) U.S. Cl. 719/328

(57) ABSTRACT

A network platform for supporting a network-enabled application, comprises a plurality of communication channels to respective plurality of wireless network carries, each of the wireless network carriers having a plurality of users, the network platform comprising at least one processor; at least one interface having access to the internet; a mobile desktop applications; at least one third party online application; at least one file stored on the mobile desktop; a online operating system defining one or more sequences of instructions for integrating access to the third party online application and the network application via the mobile desktop application; and an Application Programming Interface (API) defining one or more sequences of instructions for allowing a third party online application to operate with the mobile desktop to save, read, and write files, wherein execution of the one or more sequences of instructions by the processor causes the processor to receive a request from the third party online application to access a file stored on the mobile desktop, determine whether the third party online application has access right to the requested file, and allow the third party online application access to the requested file when it is determined that the third party online application has access rights to the requested file.

### RELATED APPLICATION INFORMATION

This application claims priority under 35 U.S.C. 119(e) to U.S. Provisional Application Ser. No. 61/036,430, filed Mar. 13, 2008 and entitled “Mobile Network Community Desktop API,” which is incorporated herein by reference in its entirety as if set forth in full. This application also claims priority as a Continuation-In-Part under 35 U.S.C. 120 to U.S. patent application Ser. No. 12/056,090, filed Mar. 26, 2008, and entitled “Systems and Methods for a Mobile, Community-Based User Interface,” which in turn claims priority to U.S. Provisional Patent Application Ser. No. 60/956,626, filed Aug. 1, 2007, and entitled “Systems and Methods for a Mobile, Community-Based User Interface,” both of which are incorporated herein by reference as if set forth in full.

This application is also related to Co-Pending U.S. patent application Ser. No. 11/743,040, filed May 1, 2007, and entitled “Systems and Methods for a Community-Based User Interface,” Co-Pending U.S. patent application Ser No. 11/516,921, filed Sep. 6, 2006, and entitled “Automated Billing and Distribution Platform for Application Providers,” both of which are incorporated herein by reference as if set forth in full.

### BACKGROUND INFORMATION

1. Field

The embodiments described herein relate to a social or community-based online network, and more particularly to a desktop application programming interface (API) that allows applications to operate within an online desktop application that unites social features with desktop features.

2. Background

U.S. patent application Ser. No. 11/516,921 (the '921 patent application) describes a community-based online network cite that makes various applications, termed Pods, or widgets available as well as various services, such as contact list maintenance, messaging, chat, etc. As explained, in the '921 patent application a user can access a community platform associated with the site using a browser in order to access the applications and service provided. Accessing the network in this manner is not unusual as computer and mobile device users use a multitude of applications and websites via a web browser on a frequent basis in order to communicate with others, share information, obtain information and use third-party applications for services and entertainment.

Unfortunately, the need to access such services through a browser can be limiting. For example, using a browser to access applications and services is often not as efficient as accessing applications and services on the user's computer “desktop,” i.e., applications stored on the user's actual computer. Further, alternating between desktop applications and browser applications can be cumbersome and inefficient. Navigating between multiple browser based applications can be even more cumbersome, often requiring the user to open multiple browsers.

For example, a typical user may have several address books maintained in different applications or on different web-based services to track friends, family and other contacts, thereby making coordinated management of, and communication between, all contacts difficult. In addition, the sharing of information is often difficult because the user must jump between different applications and/or websites to send or receive documents via the internet from contacts such as friends and family. For example, if a user desires to send photos to a group of friends, the user may first need to access one or more email applications to find the friends' contact information in one or more address books, and then access a particular application, such as a photo application, or a file browser, to create or access the desired data file for the photo. The user then generates an email by accessing the different address books, attaches the photo data file, and sends the email to the group of friends.

In another example, a user may subscribe to an application service provided on a website, which is only accessed through the web. In such a case, when the user wants to use the application service, the user must initiate a web browser and sign in, if necessary, rather than easily access the application service just like any other application on the user's desktop.

Community-based services are becoming more and more popular. In other words, it is not enough to provide users with email, word processing, spread sheets, etc. Rather, many users want to be able to create content with such programs and share them with a group of friends, or “buddies,” quickly and easily. Unfortunately, today's online and desktop applications and services do not allow the type of easy integration between applications and community needed to provide such functionality.

### SUMMARY

A network platform for supporting a network-enabled application, comprises a plurality of communication channels to respective plurality of wireless network carries, each of the wireless network carriers having a plurality of users, the network platform comprising at least one processor; at least one interface having access to the internet; a mobile desktop applications; at least one third party online application; at least one file stored on the mobile desktop; a online operating system defining one or more sequences of instructions for integrating access to the third party online application and the network application via the mobile desktop application; and an Application Programming Interface (API) defining one or more sequences of instructions for allowing a third party online application to operate with the mobile desktop to save, read, and write files, wherein execution of the one or more sequences of instructions by the processor causes the processor to receive a request from the third party online application to access a file stored on the mobile desktop, determine whether the third party online application has access right to the requested file, and allow the third party online application access to the requested file when it is determined that the third party online application has access rights to the requested file.

### BRIEF DESCRIPTION OF THE DRAWINGS

Features, aspects, and embodiments are described in conjunction with the attached drawings, in which:

FIG. 1 is a block diagram that illustrates an exemplary computer system that can be configured to implement the systems and methods described herein;

FIG. 2 is a block diagram that illustrated a computer-based mobile community in accordance with one embodiment;

FIG. 3 is a block diagram that illustrates a more detailed view of the high-level system view of FIG. 2;

FIG. 4 is a flowchart illustrating an example method for distributing an application via the mobile community architecture of FIG. 2;

FIG. 5 is a diagram illustrating an example application user interface for an application developed and registered with the system of FIG. 2 in accordance with one embodiment;

FIG. 6 is a diagram illustrating an example user profile page that can include applications, such as the application of FIG. 5, and can be hosted by the mobile community architecture of FIG. 2;

FIG. 7 is a flowchart illustrating an example method for a user to add an application to their profile page;

FIGS. 8 and 9 are flowcharts illustrating the operation of an application and its associated pod application within the mobile community of FIG. 2;

FIG. 10 is a block diagram of a global mobile platform that can be included in the computer-based global mobile community of FIG. 3;

FIG. 11 is a block diagram illustrating a computer-based mobile community platform that includes a mobile desktop application according to one embodiment;

FIG. 12 is a screen shot illustrating a main desktop view that can be shown within the mobile desktop application of FIG. 11;

FIG. 13 is a screen shot illustrating the capability for a user to monitor who is accessing the user's public desktop within the mobile desktop application of FIG. 11;

FIG. 14 is a diagram illustrating the mobile desktop of FIG. 11 integrated with various resources in accordance with one embodiment;

FIG. 15 is a diagram illustrating the capability for a user to share access to documents on the user's mobile desktop in accordance with one embodiment; and

FIGS. 16-24 are screen shots illustrating various components and features of a mobile community platform network API that can be implemented in conjunction with the mobile desktop application of FIG. 11 in accordance with one embodiment.

### DETAILED DESCRIPTION

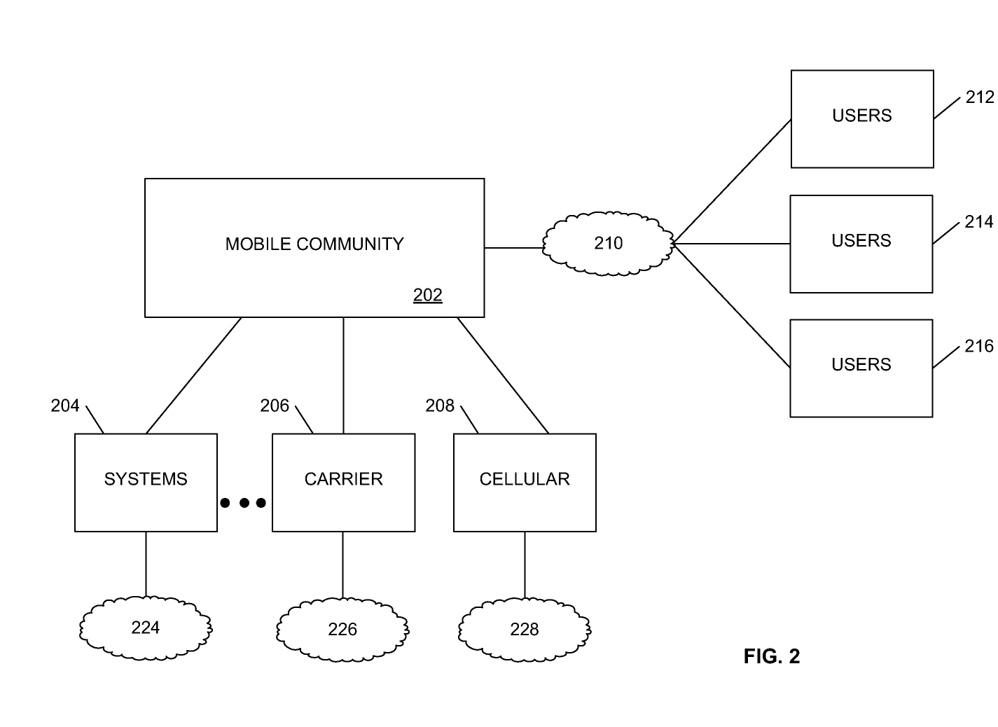

FIG. 2 depicts a block diagram of a computer-based mobile community 202. Users 212, 214, 216 can connect to the mobile community 202 via a network or similar communications channel 210. Via the connection, a user (e.g., 212) can create a profile page or “home page” that they can personalize. This profile page can include various files and content that the user wants to share with other members of the mobile community 202.

The profile page may include a hierarchy of pages, some of which are for public view and some of which have restrictions on viewing. For example, the mobile community 202 can be logically organized into neighborhoods such as “friends”, “family”, “workplace”, “dog owners”, etc. Users 212, 214, 216 can belong to these different neighborhoods and share different pages with the members of the different neighborhoods.

Additionally, this mobile community 202 connects with various wireless carrier systems 204, 206, and 208, each of which has an associated community of mobile phone subscribers, 224, 226 and 228. Users 212, 214, 216 of the mobile community 202 are also subscribers of various wireless carriers. In this way, users 212, 214, 216 of the mobile community 202 not only have access through the computer-based platform 202 to other users' profile pages, they also have easy access to subscribers of the various wireless carrier systems 204, 206, 208.

A benefit of the architecture depicted in FIG. 2, is that the mobile community platform 202 has already contracted for services with the wireless carrier systems 204, 206, 208. As is known in the art, the wireless carrier systems 204, 206, 208 provide messaging and premium message functionality. Such messages are sent via the wireless carrier's infrastructure to mobile subscribers and, internal to the wireless carrier's infrastructure, a billing event is generated according to a particular tariff rate. In practice, when the mobile community 202 sends a message via a wireless carrier system (e.g., 204), it is billing the recipient of the message using the existing billing system of that wireless carrier. The billing event is often a micro-transaction. Thus, a user (e.g., 212) of the mobile community may conduct transactions with a vendor within the mobile community 202 and be billed for those transactions via their wireless service account. The vendor in the transaction need only communicate with the mobile community 202 regarding the transaction and does not require any affiliation or agreement with any wireless carrier.

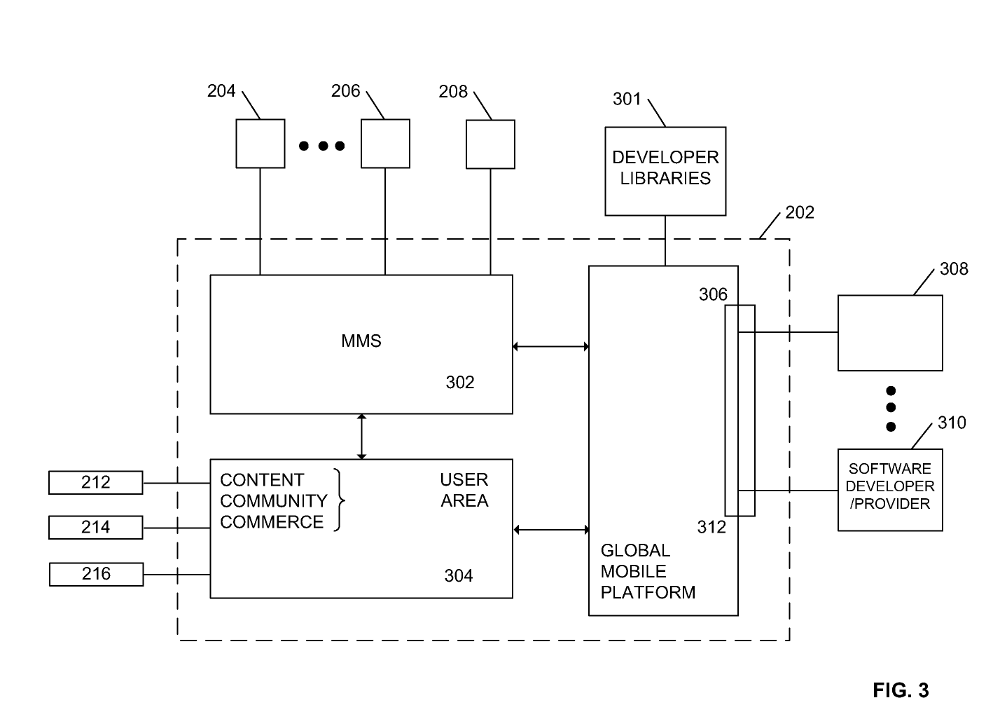

FIG. 3 depicts a more detailed view of the high-level system view of FIG. 2. In particular, the system of FIG. 3 can be used to conduct micro-transaction in which a wireless carrier's billing system is used by the mobile community 202 platform to automatically bill the user for each micro-transaction with a vendor/retailer, without the need for a negotiation or contract between the vendor and the wireless carrier. One example of this feature is that of software content distribution where software developers can offer software products to the users of the mobile community 202, while taking advantage of the billing arrangements already in place between the mobile community 202 and the wireless carriers 204, 206, 208. Of course, a software application can provide any other type of content or service to users of mobile community 202.

Some of the sub-components of the mobile community 202 are a global mobile platform 306, the user area 304 where the content, community and commerce functions are handled for the users, and a multimedia messaging system 302. The details of these different sub-components are more fully explained throughout the remainder of this detailed description.

As noted earlier, users 212, 214, 216 can visit the user area 304 to participate in an on-line community that includes various content and commerce opportunities. This is typically accomplished via a user's web browser that may be hosted on a laptop or desktop computer, or, in the alternative, even on the user's mobile device such as a PDA or mobile phone. Thus, the user area 304 includes a web server that communicates with users 212, 214, 216 and includes a data store of user information and other content. With these resources, the mobile community 202 is able to present to a user 212 a profile page (“home page”) that reflects content and information associated with, and desired by, that particular user. This content and information is not maintained on the local computer being used by the user 212 but, rather, is maintained and managed by the computer systems within the user area 304.

Although not explicitly depicted in FIG. 3, one of ordinary skill will recognize that there are numerous functionally equivalent techniques to create, manage, store and serve user information, user profiles, user content, software tools and other resources within the user area 304. Included in these techniques are methods to ensure security, data integrity, data availability and quality of service metrics.

The multimedia messaging system 302 includes applications for connecting with and communicating with the multiple different wireless carriers 204, 206, and 208 that have been partnered with the platform of mobile community 202. The MMS 302 is configured to generate message requests in the appropriate format for each of the wireless carriers 204, 206, 208 including tariff information that determines the amount for which the recipient of the message will be charged. Upon receipt of the message request, the wireless carriers 204, 206, 208 will use the information in the request to generate an appropriate message to the intended recipient/subscriber of the wireless carrier and then bill the recipient/subscriber's wireless service account for the specified amount.

The MMS 302 communicates with the user area 304, such that users of the mobile community 202 can advantageously use the connectivity of the MMS 302 with the carriers in order to send messages to subscribers of any of the wireless carriers 204, 206, 208. The messages can be SMS messages, MMS messages, or other message formats that are subsequently developed. Some of these messages can have zero tariffs and, therefore do not generate a bill (other than the underlying charges implemented by the wireless carrier) and others can have non-zero tariffs resulting in a billing event for the recipient.

The global mobile platform 306 provides a link between application developers/providers 308, 310 and the mobile community 202. In particular, using an interface 312 (described in more detail herein), an application software provider 308, 310 can offer services and products to users 212, 214, 216. For example, application providers 308, 310 can develop and distribute various pods, or widgets. Advantageously for the application providers 308, 310, the global mobile platform 306 also provides automatic and instant connectivity to the MMS 302 and the wireless carriers 204, 206, 208. Accordingly, the application providers 308, 310 can interact with all users of the mobile community 202 whereby billable transactions with users 212, 214, 216 are automatically billed via the billing systems of the wireless carriers 204, 206, 208. Furthermore, and importantly, this capability is available to the application providers 308, 310 without requiring the application providers 308, 310 to negotiate or contract with any wireless carrier for billing arrangements, or to worry about how to communicate with a wireless carrier's systems and resources. The software provider seamlessly takes advantage of the unified set of connectivity and billing arrangements that exist between the mobile community 202 and the wireless carriers 204, 206, 208. Thus, in addition to the contractual arrangements and affiliations the mobile community 202 has in place with different carriers 204, 206, 208, the underlying technical and communications infrastructure is also in place to communicate with and interoperate with each of the different carriers 204, 206, 208. As a result, vendors and other members of the mobile community can interface with and operate with any of a variety of different carriers without difficulty.

While some applications, e.g., pods, widgets, etc., available to users 212, 214, 216 can be hosted in the user area 304, the global mobile platform 306, or elsewhere in the community 202, it is often the case that the application providers 308, 310 will host their own applications at their own remote location. Accordingly, in the description that follows, even if a remotely-hosted application is being discussed in a specific example, one of ordinary skill will readily appreciate that the application being hosted differently is also expressly contemplated.

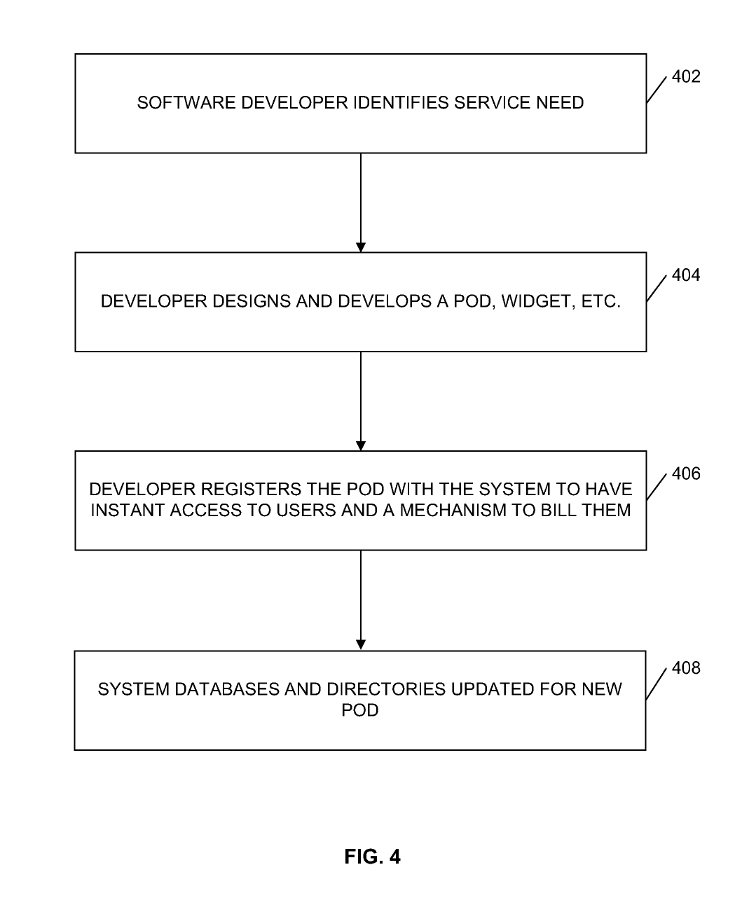

FIG. 4 depicts a flowchart of an exemplary method for distributing an application, e.g., a pod or widget, via the mobile community architecture of FIG. 2. In a first step 402, an application developer identifies a marketplace need that is not being fulfilled. In other words, the developer believes that there is a service or product that they can provide that will be profitable. The variety of different types of services, content and products that can be offered to users via an application such as a pod, widget, etc. is limited only by the imagination of the different developers.

The terms “pod,” “widget,” “pod service,” “pod application,” “widget service,” “widget application,” etc., are used in the following description as a label for a software application, or application offered through the mobile community 202. This label is used merely for convenience and is not intend to limit or restrict the types, variety and capabilities of potential software applications offered through mobile community 202 in any way. As used herein, these terms refer both to the underlying information related to the application and to the graphical rendering of the application, e.g., on a user's profile page within the mobile community 202 or without.

Once the marketplace is identified, the developer commences development of their application in step 404. The underlying application logic is up to the developer and can utilize any of the widely known programming environments and techniques available to one of ordinary skill in this area; however, the application will be offered within the mobile community 202 along with a variety of other applications. Accordingly, standardizing the look and feel of the application and information about the application can aid the users 212, 214, 216 and make their community experience more enjoyable.

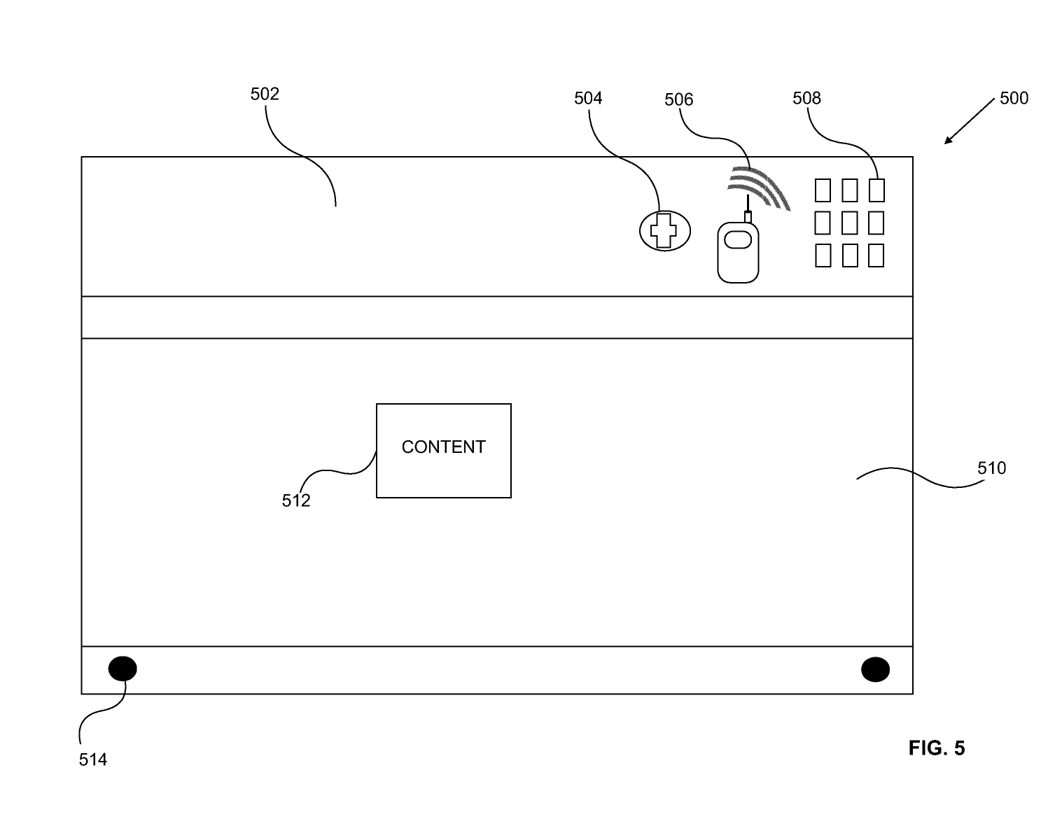

Once an application has been developed (and most likely tested and verified) by a developer, the developer registers, in step 406, the application with the global mobile platform. Registering the application, which is described in more detail with respect to FIGS. 5-8C of the U.S. patent application Ser. No. 11/743,040 (the '040 application) referred to in the section entitled “Related Application Information,” allows the software developer to inform the global mobile platform 306 that a new application is available for the access by mobile community 202.

Once an application is registered, the global mobile platform 306 can update, in step 408, system databases and directories for the new application and its associated information. In the above description of FIG. 4, it is evident that the application developer communicates with the mobile community 202 for a number of different reasons. One of ordinary skill will recognize that these various communications between the application developer and the mobile community can occur via any of a variety of functionally equivalent means. For example, both wired and wireless communication methods for these communications are explicitly contemplated.

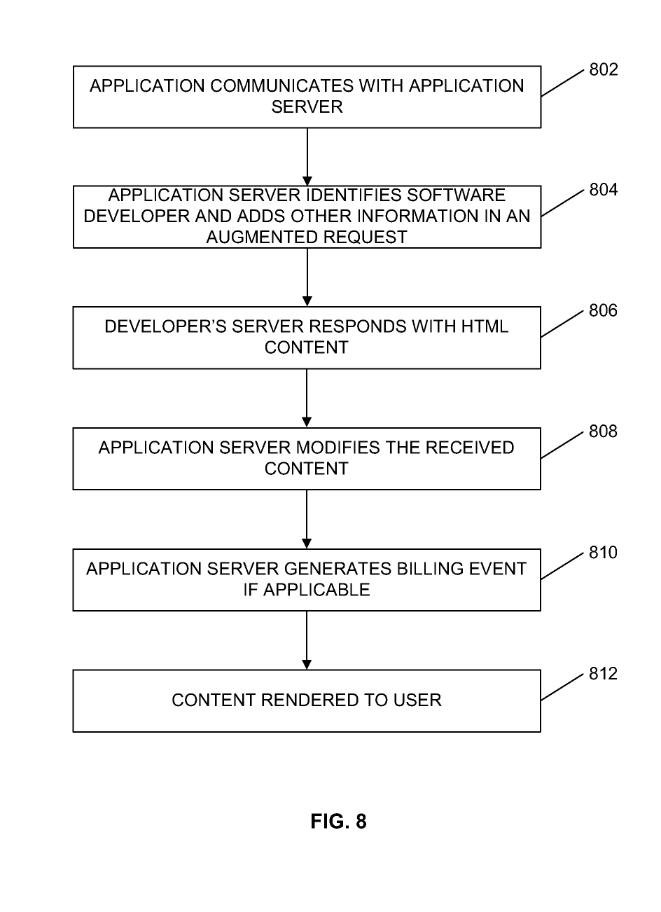

During registration of an application, the global mobile platform 306 can collect additional information that is associated with the application. This is described in more detail with respect to FIGS. 8A and 8B of the '040 application. For example, the developer can select an appropriate pricing scheme, according to a standardized pricing structure. According to one embodiment, pricing occurs in fixed tariff bands. For example, one band would be a $0.25 band and would be used for products or services that the developer thinks users would purchase for around $0.25. Another band may be $1.00 and would be for higher priced items and still other bands can be used as well. According to this arrangement, not all prices are available to the developer; instead, the developer picks the closest band to use (e.g., the $1.00 band is selected even if market research shows users would actually pay $1.03 for the service).

Additionally, the application will likely be used by people in different countries. Because of the vagaries of global economics, $0.25 may be too high of a price-point in many countries. Thus, it is more appropriate to set a price-point for each separate country from which the application may be used. While it is possible for the global mobile platform 306 to permit the developer to set such a vast number of price-points, most developers will not have the knowledge or the patience to perform such a task. Accordingly, the global mobile platform 306 can automatically provide a price band selection for each country based on their respective costs of living. In other words, a developer can select a price band in the currency that he is comfortable with and let the global mobile platform 306 translate that to an equivalent price band in each country.

The developer can also specify the number of messages and frequency thereof that their application will send to each user. Based on their knowledge of having developed the application to perform a particular service, the developer may, for example, know that no more than 4 messages per day (per user) will be sent from their pod application. This information sets the terms and conditions for billing the user. As explained later, the global mobile platform 306 can use this information to control message traffic within the community 202.

The benefit of specifying the pricing information and number of message information is that the terms and conditions of the pod application can be provided to a user in a uniform manner. Thus, a user of the community does not have to learn and interpret different pricing information for each different pod developer. Instead, the uniform format simplifies understanding this information. The exemplary format can provide a variety of information about the application. With such a uniform pricing arrangement being utilized, it becomes possible to monitor the behavior of developers with respect to their specified pricing structure and implement control measures such as limiting or restricting their activities within the mobile community if warranted.

Depending on the embodiment, the application can be evaluated by a moderator of the mobile community 202 to ensure it is acceptable from a technical and content point of view for the community 202. In this scenario, the application is not registered until the evaluation is completed satisfactorily.

Information about a registered application is stored within the global mobile platform 306 in such a way that when a user wants to include an application on their profile page, the application can be rendered using the stored information and interaction between the application and user will occur based on the stored information as well. In such a case, the data associated with the user will be updated to reflect that the user is now accessing and using the application.

Thus, according to the previously described technique, a developer can automatically register a new application (even from a remote location) without difficulty in such a way that the application automatically becomes available to users of the mobile community 202 at the conclusion of the registration process. Furthermore, from the developer's point of view, the application can immediately take advantage of the billing platform used by the mobile community 202 without the need to have existing contracts in place with one or more wireless carriers.

One benefit of registering applications in this manner is that once registered, the global mobile manager 306 can prevent the terms and condition information from being changed by the developer. Thus, a user's agreed upon price and operating parameters will not be modified (with or without their knowledge).

The users of the global community can locate available applications, e.g., pods, widgets, etc., in a number of different ways. First, the community 202 facilitates sharing of information by people having common tastes. Accordingly, within the community users frequently visit other users profile pages looking for interesting content and information, particularly with neighborhoods to which the user belongs. During this visiting of other members' home pages, a user can discover an interesting application and want to get it. In terms of the community, a user “owns” their own profile page and is called an “owner” when at their profile page. In contrast, when a user visits some else's profile page, they are considered a “viewer”. Within the mobile community 202, the profile pages are maintained such that the view by an owner may not always correspond to that seen by a viewer as the owner may want some information to be private and other information to be public.

In another instance, a user may know a friend or colleague would want a particular application; thus, the community 202 allows a user to inform another user about the existence of a new application. Another way in which applications are located is via a directory within the mobile community 202. For example, the global mobile platform 306 registers each pod application as the developers submit them; it is a simple extension to include a database update and a searchable-directory update as part of the registration process (see step 408 of FIG. 4).

A rendering of an exemplary application 500 is depicted in FIG. 5. The application includes a title bar 502 with a number of icons 504-508. The main window 510 of the application is where the content 512 is displayed. This content is based on the associated application and the stored system information associated with the application. From the pod 500, a user launches an initial message to the associated application. In instances where the application provides content back to the application 500, the window 510 is updated. By using remote scripting capability, as is known in the art, the updating of window 510 can occur without the user manually refreshing the window 510. Similar to the profile pages described earlier, the application 500 can be designed to provide different views of content 512 to a user depending on whether the user is an “owner” or a “viewer”.

The icon 504 can be selected by a user (for example, when viewing someone else's application) to add that application to their own profile page. The icon 506 can be selected to inform another user about this application and a drag icon 508 can be used to move the application around a user interface screen. The “information” icon 514 is useful for displaying information about the application, including the uniform pricing information described earlier.

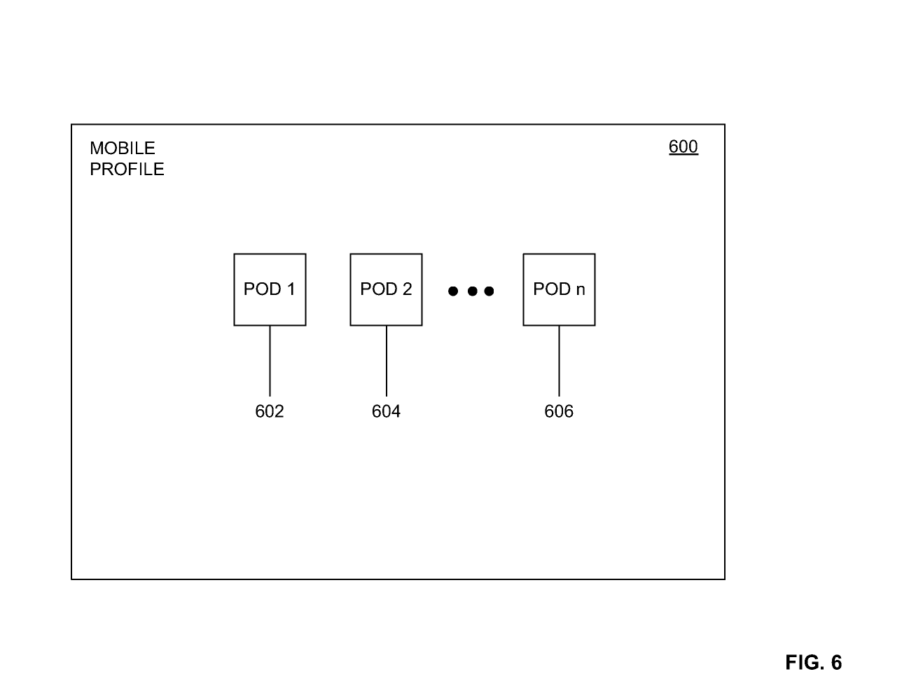

FIG. 6 depicts an exemplary user profile page 600 that has arranged thereon a plurality of applications 602, 604, and 606. In this manner, the applications available to a user can be displayed on their profile page. As noted earlier, the user can access this profile page via a number of different devices. For example, in addition to use of a traditional web browser, a portable device such as a smart phone or PDA can be used to access the profile page and pods. Such portable devices can utilize traditional WAP-based or HTML-based techniques to access the applications but they can also use device-based applications with proprietary protocols specifically developed to advantageously use the capabilities provided by the applications 602, 604, and 606. Other example techniques implemented by portable devices that can be configured to access a profile page described herein include BREW, J2ME, etc.

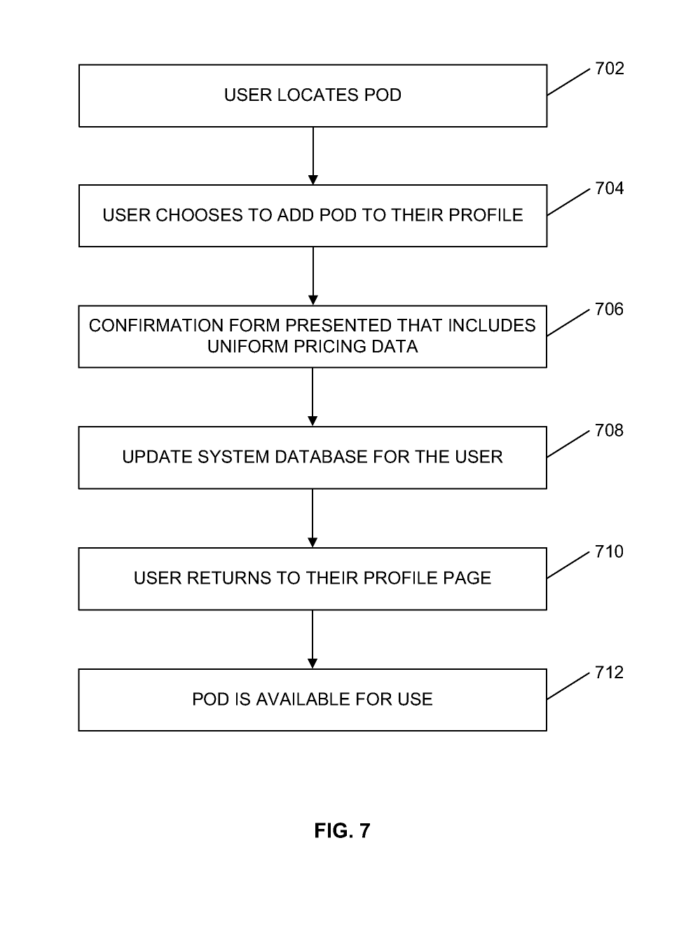

FIG. 7 illustrates a flowchart of an exemplary method for a user to add an application to their profile page. In step 702, the user locates an interesting application, e.g., via a visit to another user's profile page or through a directory search. In evaluating the application, the user can see the terms and conditions of the application in the uniform presentation format described earlier. Next, in step 704, the user chooses to add the application to their profile page; typically using a standardized feature on the application. In step 706, a confirmation page is sent to the user to ensure they know the pricing information about the application and to ensure they are aware of the likelihood of their wireless service account being billed as a result of executing the application. Assuming the user confirms their selection, the user area 304 updates, in step 708, its data store about this user such that the records indicate the user owns this new application on their profile page. When the user next visits their profile page, in step 710, and as a result of the user area 304 rendering their profile page on their browser, the new application will be displayed. With the application displayed within the profile page, it is now available for use by the user, in step 712.

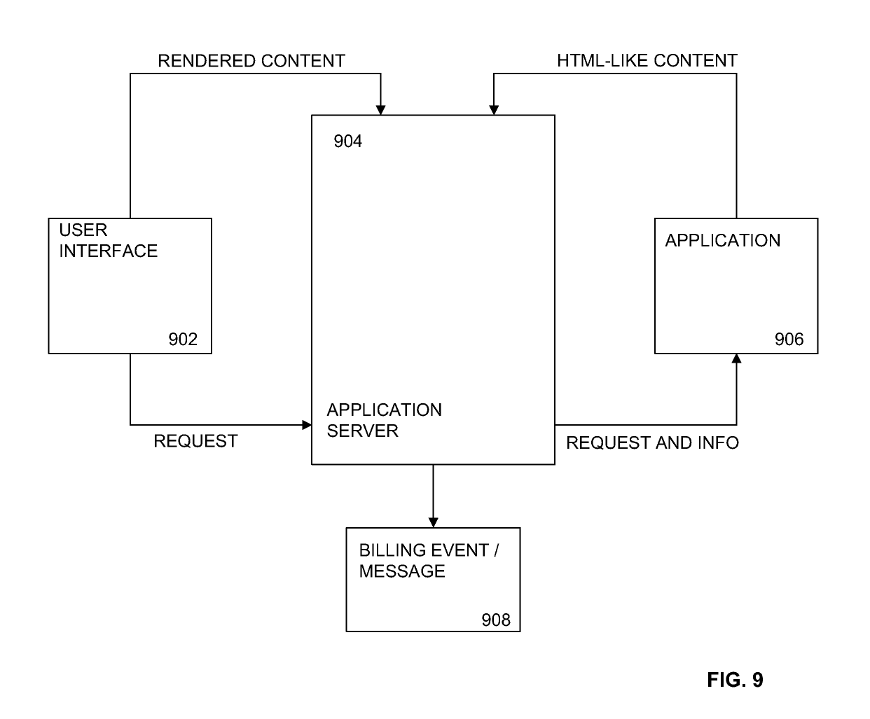

FIGS. 8 and 9 illustrate the operation of an application within the mobile community 202. As known to one of ordinary skill, the application server 904 can be a process executing on a separate, dedicated processor or can be included as part of the user area 304 or the global mobile platform 306. In step 802, a user interacts with some feature on the application user interface 902 to generate a request. This request includes the URL associated with the content of the application and a query string (if any) based on the fields of the application, and information input by the user. The query string is sometimes referred to as transient parameters.

In response to the request from the user interface, 902, the application server 904 identifies the associated application developer and the URL of the content and adds some additional information, in step 804. The augmented request is sent to the developer's server 906, which responds, in step 804, to the augmented request.

The information added to the augmented request can include demographic information about the owner and viewer of the application. In this way, the server 906 can respond with a first type of content if the owner and viewer are the same or respond with different content if the owner and viewer are different. One way to accomplish this distinction is for the user area 304 to refer to users by a unique user ID number. Thus, users can be distinguished without revealing sensitive information to the developer, such as the mobile telephone number of a user. Also, the server 906 can use this demographic information to collect statistics about its users.

Other additional information that can be added would include details about the type of user interface the user has available. Because users may be using their mobile device, their display may not be as robust as a desktop interface. Thus, a server 906 can control content based on the current graphical and bandwidth capabilities of the user. For example, the additional information can indicate whether the user is operating in a web-based or mobile-based environment, e.g., a WAP, BREW, J2ME, etc., based environment.

In response to the augmented request, the server 906 can respond with code, in step 806, that is substantially HTML data. This code can be generated according to the application logic associated with the application. In other words, it is the content that is returned to the user who is viewing the application. In certain embodiments, the code of the response varies from conventional HTML in certain ways. For example, because this is a managed communication system, non-standard HTML tags can be used and supported. Thus, non-standard tags can be used that are specific to the application environment and that are not applicable to generic HTML pages. For example, the types of applications being described have a title area and a message area. Tags specifically for controlling these areas can be used to add functionality to the application environment described herein. One of ordinary skill will recognize that a number of different specialized tags and capabilities can be offered without departing from the scope of the embodiments described herein.

An additional variation from HTML is that of using templates where information can be provided by the application server 904. For example, for privacy concerns, little identifying information is sent to the server 906. However, the application server 904 can have access to this information because it communicates with the user information stored in the user area 304. Thus, the use of templates can allow server 906 to take advantage of this information to personalize the application experience. For example, the template may include a tag <! FirstName !>. When the application server 904 encounters this tag in the template, it knows that the server 906 intends for the application server 904 to insert the first name of the user.

When the application server 904 receives the HTML-like reply from the server 906, the application server 904 manipulates the reply into a format useful for the application environment. For example, certain HTML features such as, for example, javascript, iframe, frame, and script features, are removed from the reply in order to improve the security of the content. Secondly, the application server 904 can replace the personalizable parameters in the templates with the actual user information. And thirdly, the application server 904 can translate the content into other display formats, depending on the operating environment of the user (mobile or computer).

For example, if a developer is well-skilled in providing WAP code as opposed to conventional HTML code, then the developer can control which code, or content, is generated based on the information it knows about the user's interface. However, if the developer is not skilled with, or does not support, generating content in different formats, then the software application can request (as part of the code it sends back to the application server 904) that the application server 904 translate the code into a more appropriate format.

Another modification the application server 904 can make is that of manipulating the hyperlinks within the code sent by server 906. Under normal behavior, such a hyperlink would result in opening another browser window and following the link. In certain embodiments, however, the original hyperlinks are adjusted by the application server 904 so that following of the links remains under the control of the application server 904 and the user interface remains within the focus of the application instead of some other browser window.

Once the server 904 completes its changes to the original code in step 808, the server 904 renders the code and content to the user's application 902, in step 812.

In addition to the code that is received from server 906, the application server 904 can also receive information from the server 906 about a billing event that should be triggered for the particular content that the user requested. For example, the user may have requested a stock quote that will cost $1.00. When server 906 generates the content of the reply, it also generates a message that the user should be charged $1.00 for this transaction. One of ordinary skill will appreciate that there is wide variety of protocols for the application server 904 and the server 906 to exchange information related to a billable transaction. During operation, therefore, the server 906 merely adheres to the agreed upon protocols to inform the application server 904 that a billable transaction has occurred.

When the application server 904 determines that the code from the server 906 includes an indication that billing should occur, the application server 904 generates a billing event 908, in step 810. This billing event 908 is forwarded to the global mobile platform 306 so that billing can occur by using the wireless carrier's underlying billing systems. The application server 904 has access to the recipient information (i.e., the user) and the billing rate of the application. Therefore, an appropriately formatted billing message is easily generated.

The global mobile platform 306 includes a message interface 1002 to handle billing events from a variety of sources. Although a different interface could be designed for each different source of billing events, it is more efficient to use a single Application Programming Interface (API).

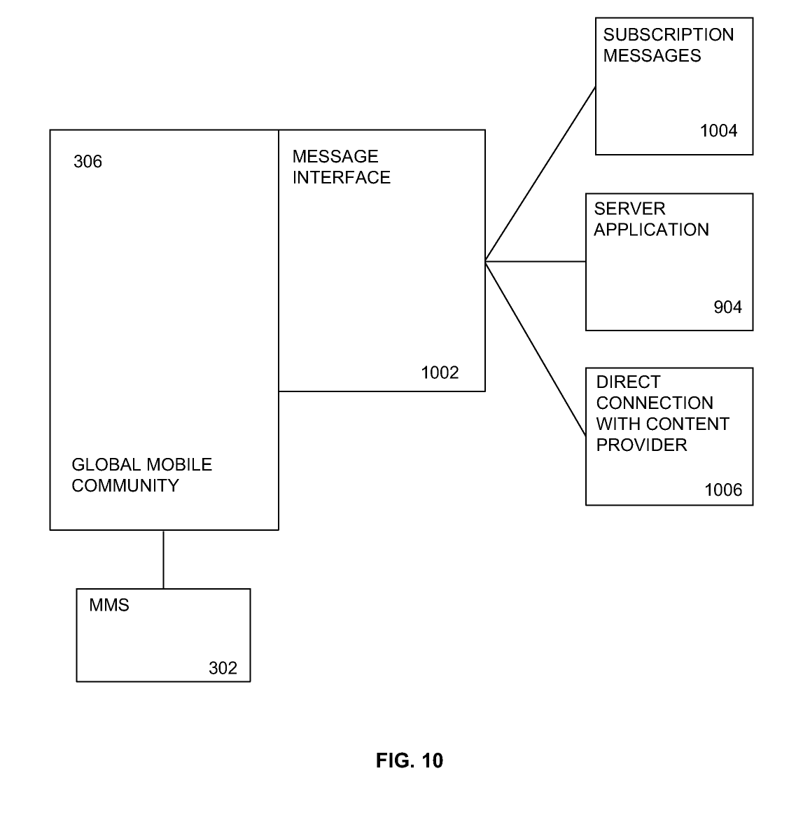

One type of billing message can originate from subscription-based services. Under these circumstances, a database or other storage system maintains a record of when to send a message to a user on a predetermined periodic basis (e.g., daily, monthly, weekly, etc.). When the management system for these subscription services indicate that a message is to be sent, then this message is forwarded to the interface 1002 (FIG. 10) of the global mobile platform 306 with the appropriate tariff information included.

As discussed earlier, the application server 904 can also generate a message based on a discrete billable event occurring due to the user's operation of an application. In this instance the billing message 908 is forwarded to the interface 1002.

In another circumstance, the application may operate so as to avoid sending content back through the application server 904 but still be designed to perform a billable event. For example, the application may be a virtual greeting card application that sends text messages to people based on whether it is their birthday, anniversary, etc. and charges the pod user $0.25 for each card. Thus, the application performs billable activities but not via the content it sends back through the application server 1304. Under these event-based circumstances, the developer can establish a direct connection with the interface 1402 and send a billable message via the established API.

Regardless of how the billable event arrives at the interface 1002, the global mobile platform 306 processes it such that a message is sent via the MMS 302 through the wireless carriers to the user of the pod. This message, the content of which may say, for example, “Thank you for being a valued customer of xxx” will have associated with it a tariff code that results in the user being billed via their wireless service account.

Thus, a model is established where the wireless carrier bills a user for various events and shares an agreed-upon portion of that billing with the mobile community platform who, in turn, shares an agreed-upon portion of that billing with the developer. The carrier benefits from additional billable data traffic and the developer benefits by obtaining instant access to all the users of the mobile community as well as instant access to the wireless carriers' billing systems in a seamless and unified fashion through the platform.

The presence of the global mobile platform 306 between the developer's server 906 and the MMS 302 provides the benefit that the messaging of different users of the mobile community 202 can be controlled to ensure the mobile community 202 is more enjoyable.

Within the mobile community, the various computer-based components discussed thus far have a vast amount of information stored and readily accessible. For example some of the information includes: identifying information about each application, identifying information about each user, identifying information about which applications are associated with each user, information about the terms and conditions regulating the operations of an application, and information about messages being sent via the mobile community 202. With this information available, one of ordinary skill will recognize that a number of operating parameters of the mobile community 202 can be monitored and controlled.

It should be understood that the embodiments described herein allow vendors of all types of products and/or services to charge for their products via the mobile community's existing connectivity to the various carrier systems. In practice, a purchaser would consummate a transaction with a vendor for some product or service and, in the process, provide to the vendor a means of identifying that user within the mobile community. The vendor, in turn, will communicate with the mobile community (e.g., via the Global Mobile Platform) to initiate a billing event that identifies the purchaser and the transaction amount. As explained above, this billing event will result in the purchaser being billed via their wireless telephone subscriber account. In this way, the wireless telephone account (although this information is not necessarily revealed to the vendor) acts as a virtual wallet allowing the purchaser to easily pay for a variety of different types of transactions.

As mentioned above, mobile platform 202 makes available a plurality of services and applications, e.g., widgets or pods to users 212-216. But also as mentioned above, the users 212-216 must access mobile platform, and the applications and services provided, using a browser, which can make integrating the use of such applications and services with the use of applications stored on the users' desktop difficult, or at least inconvenient. In certain embodiments, mobile platform 202 can be configured to provide many of the applications normally stored on a user's desktop.

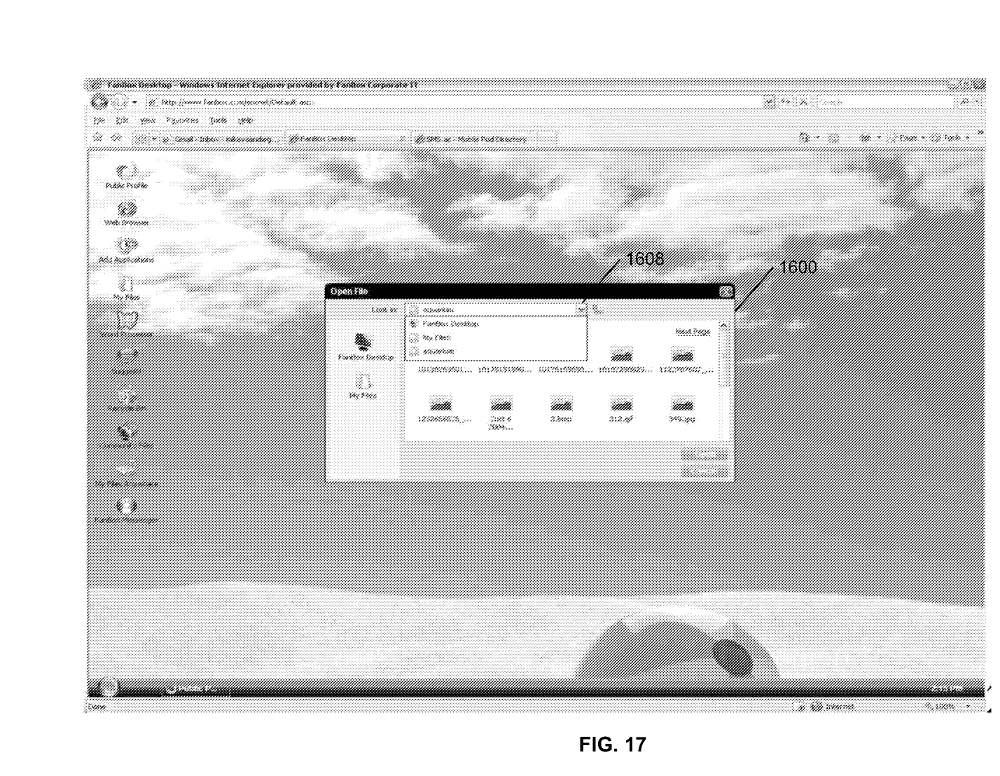

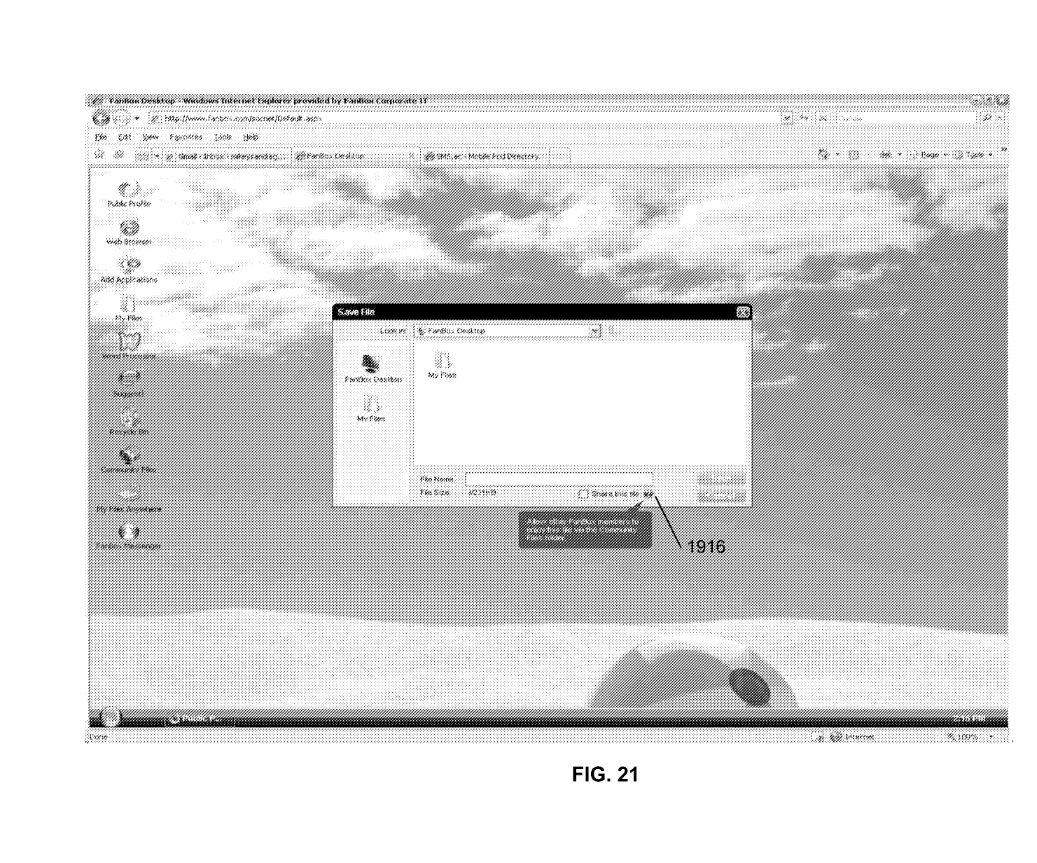

FIGS. 17-35 of the '040 application describes how the community-based applications and services provided by mobile platform 202 can be integrated in a more seamless fashion with desktop-based applications and services via a desktop user interface application. The user can then elect to download the desktop user interface application to the user's computer by selecting a download module on platform 202.

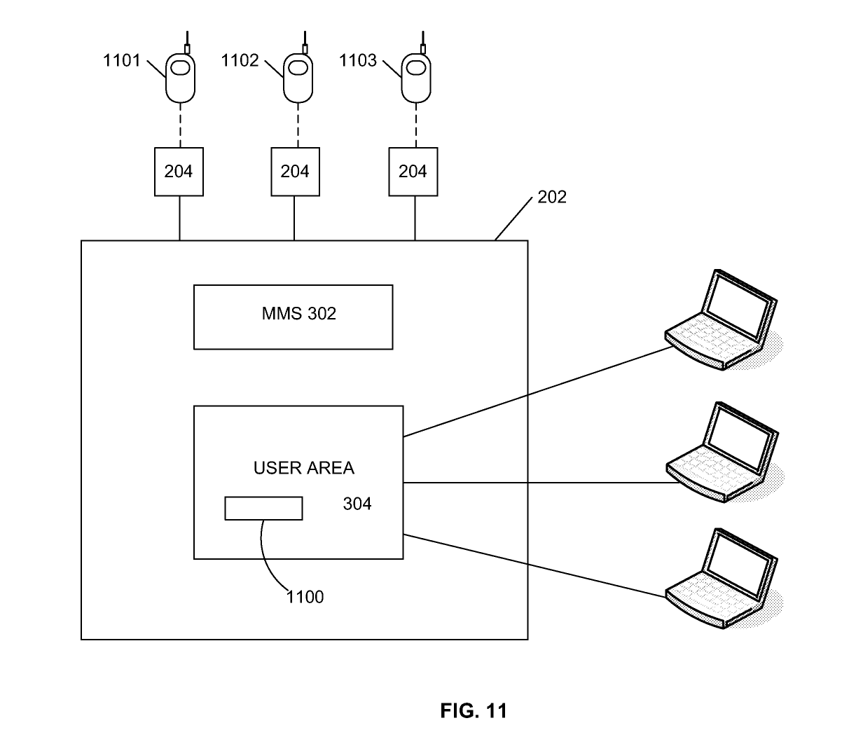

The embodiments of the desktop application described in the '040 application are generally described in relation to a desktop computer; however, the desktop application can also be downloaded to a mobile device, such as devices 1101-1103 (FIG. 11). A mobile device can include a wireless type handset, as well as a Personal Digital Assistant (PDA), palm computer, digital music player, or even a laptop or portable computing device. In general, the desktop application can be downloaded to any device that includes an operating system capable of supporting the desktop application.

In fact, due to the extensive use of such mobile devices it can be more convenient to provide access to a “mobile desktop application,” e.g., an online desktop application provided via platform 202, which performs many of the same functions as the desktop application described above. In other words, the desktop application in the '040 application unites the social aspects of platform 202 with the convenience and functionality of the desktop environment; however, as society becomes more and more mobile, individuals are not as tied to their desktop computing devices. And while a mobile device can be used in conjunction with the desktop application as described in the '040 application, this is not always a convenient or workable solution. For example, a mobile device may not have the resources needed to take full advantage of the desktop application, i.e., the mobile device may not support or have sufficient resources for any, or many desktop applications. In which case there is not much advantage to integrating the social aspects of platform 202 with the application available on the mobile device.

Additionally, it can be more convenient to be able to leave the desktop device at home and still have access to a mobile desktop that combines the functionality, e.g., programs, of the desktop environment with the social aspects of platform 202. Laptop computers are becoming smaller and smaller, but anyone who travels knows that it can still be cumbersome to travel with all the cords and battery packs needed to make efficient use of a laptop. Accordingly, it can be advantageous to eliminate the need to travel with even a laptop and simply use a computer or terminal available at a destination, or use a mobile device to access a mobile desktop application.

In this regard, FIG. 11 is a block diagram that illustrates initial access to a mobile desktop application provided via platform 202 according to one embodiment. As seen in FIG. 11, a mobile desktop application 1100 can be provided in user area 304. Mobile desktop application 1100 can be accessed by users 212, 214 and 216 when the user accesses community platform 202. For example, a user can go from work to their home computer and then access user area 304 and launch their mobile desktop 1100 from home. Similarly, when the user returns to work, the user can access user area 304 from their work computer.

In the alternative, mobile device users 1701, 1702 and 1703 can access mobile desktop 1100 when they access their home page on community platform 202 through message service 302, which communicates with user area 304. In this manner, the mobile desktop application 1100 can be accessed from both computers and mobile devices in coordination with the web browser used on each device.

Mobile desktop 1100 can provide access to platform 202 via a web browser, e.g., on devices 212-116 and/or devices 1701-1703. In certain embodiments, the mobile desktop can actually be supported by an online operating system. Online operating systems are known and will not be described in detail here. Although, it should be noted that conventional online operating systems are really applications that still rely on an operating system running on the user's computer. In certain embodiments, a true online operating system can be configured to support the mobile desktop, i.e., an operating system that is not dependent on an operating system running on the user's computer.

In other embodiments, the mobile desktop can be an online application that is configured to simulate the desktop and online operating system functionalities. Further, access to online applications, e.g., word processing applications, spread sheet applications, etc., can be made available via mobile desktop 1100. In certain embodiments, online storage can also be made available. Thus, a user can access the mobile desktop and perform many of the functions they normally perform on their desktop; however, all of the resources, e.g., the operating system, applications, storage, etc., are online.

In the example of FIG. 11, the social aspects of platform 202 can also be integrated with the mobile desktop 1100, in much the same manner that these aspects were integrated with the desktop application described in the '040 application. In other words, the user's contacts, pods, content, etc., can be accessed and shared through mobile desktop 1100. For example, the user can choose to import the user's address books from other third-party applications/services, such as Hotmail, MSN, AOL, etc., so that all of the user's contacts can be aggregated in the mobile desktop 1100. Optionally, the user can select to have the mobile desktop 1100 check each of the user's third-party address books on a periodic basis (weekly, etc.) to incorporate any additions, changes, etc.

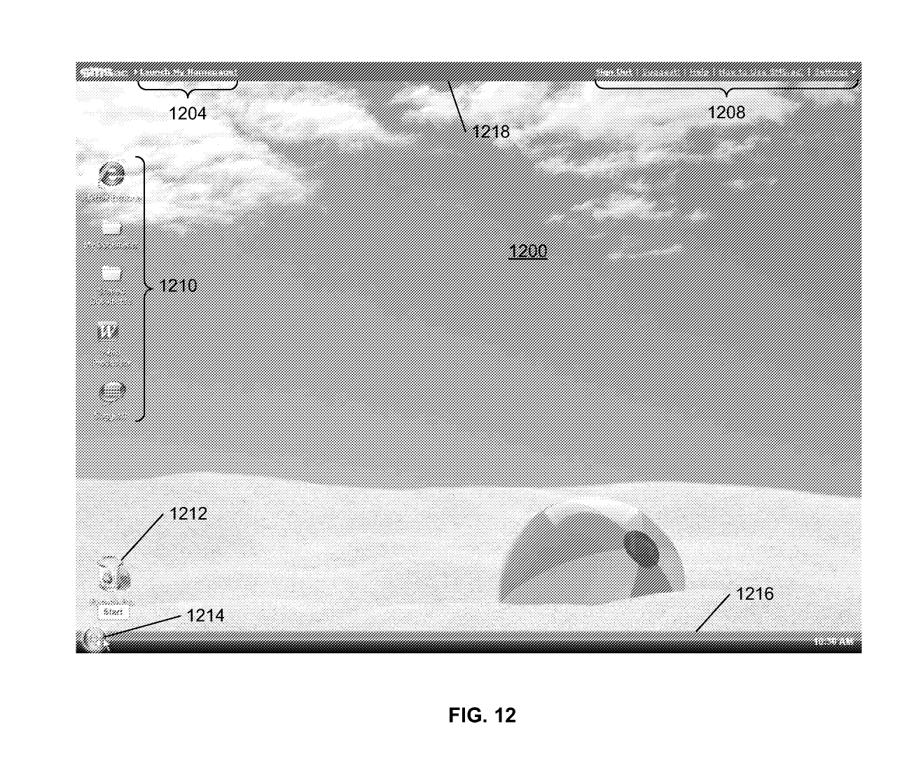

The user can sign in to the community platform 202 through the mobile desktop 1100 and remain signed in until signing out or shutting down the computer or mobile device as the case may be. An example main desktop window view is shown in FIG. 12. Once the mobile desktop 1100 is launched, the desktop view of FIG. 12 can be launched and the user can manage their contacts, communications, content applications, etc., via the mobile desktop 1100. Further, the user can create documents and content and easily share such content with their friends and non-friends. For example, as described below the user can allow friends and non-friends to view their desktop 1100 or some aspect thereof.

Thus, the mobile desktop 1100 can contain a list of all of the user's contacts, along with corresponding thumbnail pictures of the contact. In certain embodiments, the shading of each listed contact indicates whether that contact is currently available online, or away, for purposes of instant messaging. Further, in certain embodiments, the user can click on a contact to initiate instant messaging with that contact. In addition, multiple contacts can be selected by selecting and clicking on them, or rubberband selecting them by moving the cursor around the desired group of contacts.

When a contact, or multiple contacts, is selected, the user can point over the desired contact(s) and a menu can pop-up that includes icons representing various forms of communication tools for the user to select from. For example, the user can select to instant message with the contact(s), send an email to the contact(s), send SMS to the contact(s), Chat with the contact(s), use voice-over-IP (VoIP) to communicate with the contact(s), or videoconference with the contact(s). In certain embodiments, the user can also click on a contact to go to that contact's home page provided through the community platform. The user can also access their home page directly from an option in a drop down menu of the main desktop window. The user can also share content with selected contacts by attaching the content to a message to be sent to the contacts, or in certain embodiments by simply dragging and dropping selected content onto the highlighted or selected contacts.

It should be noted that in certain embodiments, access to the user's mobile desktop 1100 can be made available to other parties. For example, parties in the user's contact list can be granted access to the user's desktop, e.g. via a link on mobile platform 202. As such, the desktop application can be transformed into a public desktop that allows the user to not only communicate with other users and share files and other information from the user's desktop, as described below, but to also allow those users to actually access the user's desktop. For example, the user can select from a plurality of permission levels that grant access to no one, just friends, or anyone. Those with access can see what the user is doing, while the user is doing it, and can even access files, contacts, etc. In certain embodiments, other users can ask for permission to view the mobile desktop. Thus, even non-friends can be granted some form of access to a user's public desktop.

Within the contacts, if user is not a member of mobile platform 202, a default avatar can be assigned to that contact. When the user hovers the mouse pointer over such a contact, an invitation link can be generated for the user to invite that person to join. An email message can then be sent to that user, inviting them to join platform 202 and indicating that their friend is already using it.

Drop down menus can provide functionality for the user to add and manage the user's contacts into groups. For example, when the user selects a group drop down menu, a drop down menu can be generated that identifies all different groups the user has already created, such as family, colleagues, classmates, soccer team, surfing buddies, etc. The user can select any type of group from the drop down and a main pane will update accordingly by showing only thumbnails of such selected groups. The user can also add new groups by selecting any thumbnails from the main window and putting them into a new group by enter a new group name and clicking on submit. The user can also select any thumbnails from the main window and move them into a new group. In certain embodiments, the user can decide if this is to be a copy or move operation.

A user can select any thumbnails, i.e., contacts, from the main window and remove them from a group. If the remove action is taking place in the all contact group, the user can be warned such action will permanently remove such person from this group as well as from all other groups. The user can also add a new contact into an existing group. Any added contacts will also appear in the all contacts group. Email addresses, last names, and first names can be required entry fields when adding a contact.

In addition, drop down menus can provide functionality for the user to connect with the user's contacts and with members of the community platform via instant messaging, email, SMS, VoIP, teleconference, videoconference, blog entries, and Chat. An option is also provided for the user to go directly to a search page provided by the community platform to search for other members of the community.

Drop down menus can also provide functionality for the user to go directly to the user's homepage, access an online data storage space provided for the user by the community platform, access, e.g., an email application, calendar application, word processor application, and access the user's preferences. Help features are also provided to the user via drop down menus.

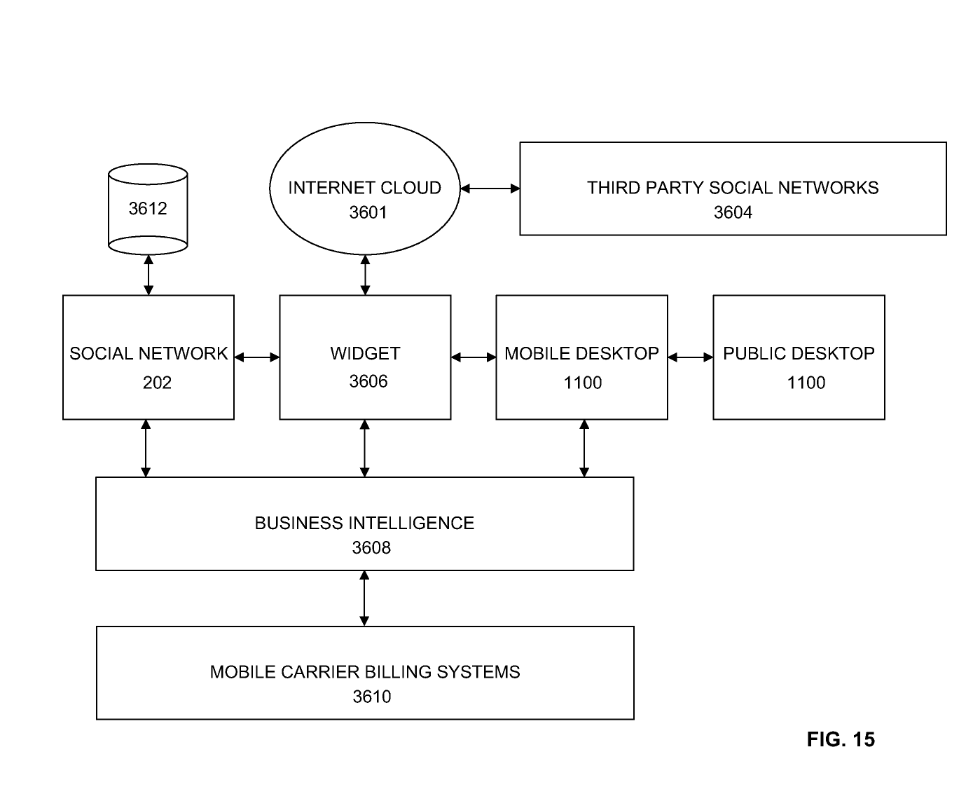

Returning to the public desktop feature, the user can set different permission levels to allow different users, different levels of access to the users mobile desktop 1100. In this manner the power of social network can be expanded by allowing others to see what the user has downloaded, what they are creating or have created, who is in their contacts, etc. It also allows the user to share content almost instantaneously. For example, the user can share documents he has created, such as those illustrated in FIG. 15, by simply providing other users with the ability to access the user's public desktop. These other users can then simply open the document and view them, essentially at will. In certain embodiments, the user can grant permission to certain users to actually access and edit content on the user's public desktop. This can allow, e.g., collaborative document creation.

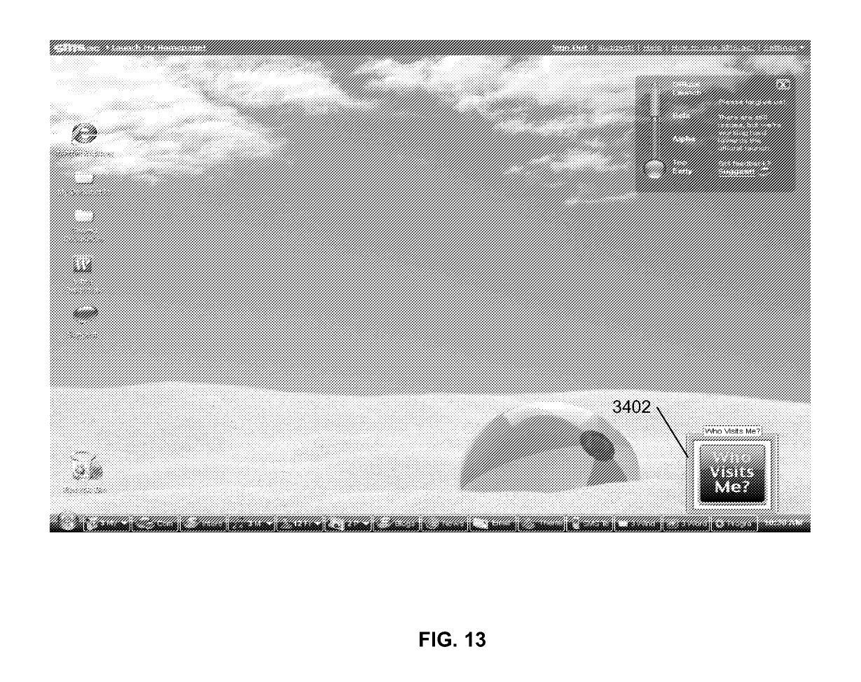

As illustrated in FIG. 13, the user can monitor who is accessing the user's public desktop via an application 3402 downloaded to the user's mobile desktop. This will allow the user some ability to keep track of who is viewing their public desktop once they have opened it up.

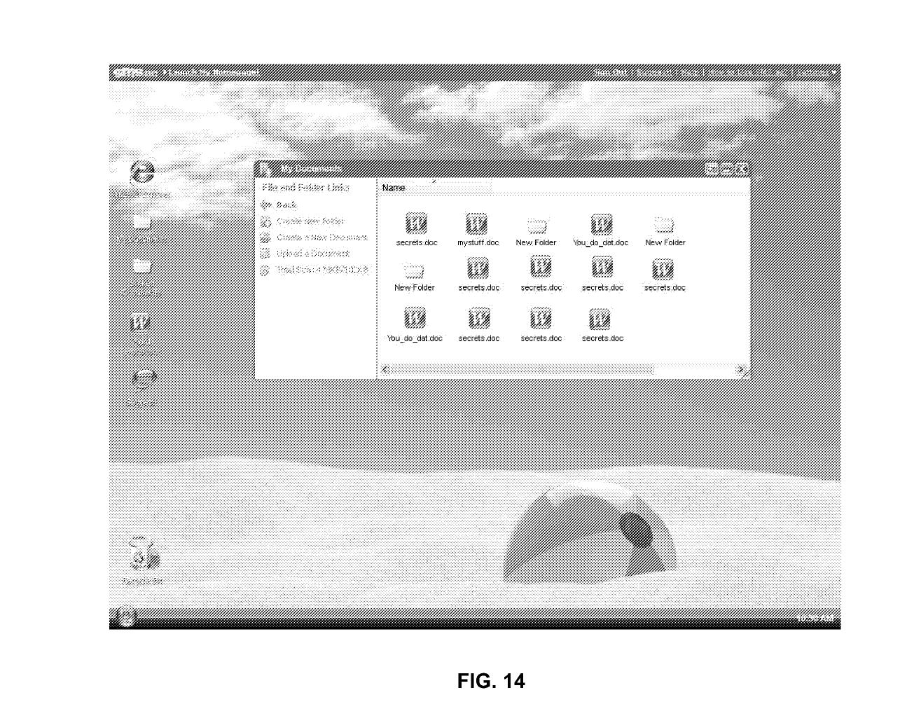

FIG. 14 is a diagram illustrating a mobile desktop application 1100 integrated with various resources via the Internet 3601 in accordance with one embodiment. FIG. 36 can be used to illustrate how mobile desktop 1100 can act as the “glue” that binds various resources together in order to turn the desktop into an e-commerce/social networking/computing center. As illustrated in FIG. 36, once mobile desktop 1100 is operating on a user's terminal, then the user can have seamless access to a plurality of social networks 3604, as well as the network provided by platform 202. Once interfaced with these networks via mobile desktop 1100, the user can download contacts and other content as described above, i.e., via a simple drag and drop process.

In other words, the user can drop pods or widgets 3606 from social networks 3604 or other public desktops 3614 to mobile desktop 1100 with an easy drag and drop process, even if the user is not interfaced with platform 202. Alternatively, the user can “pop” pods or widgets into the mobile desktop 1100. Moreover, billing intelligence functions 3608 and mobile billing capability 3610 can be provided for content and services accessed via mobile desktop regardless of whether the content, e.g., widgets 3606, or services are provided by platform 202.

Mobile billing can function as described above and in U.S. patent application Ser. No. 11/516,921 and related U.S. patent application Ser. No. 11/446,973, filed Jun. 6, 2006, which are incorporated by reference herein for all purposes. Thus, mobile desktop 1100 can provide the ability to drag and drop, or pop widgets 3606 onto the desktop 1100 and pay for the use of such widgets 3606 through mobile billing as described in the above applications. Business intelligence 3608 can then be configured to manage the billing and provide reporting functionality.

In certain embodiments, access to social networks 3604 can be achieved through mobile desktop 1100, or more accurately the web based application, or online operating system, accessed thereby, such that users can simply open their mobile desktop 1100 and browse for social networks 3604 without the need to open a separate window.

Thus, mobile desktop 1100 brings together access to social networks 3604, widgets 3606, storage 3612, public desktops 3614, billing via billing intelligence 3608 and mobile billing 3610, as well as other applications, such as word processing, spread sheets, etc., through a web based application or operating system that operates seamlessly with the desktop and desktop applications.

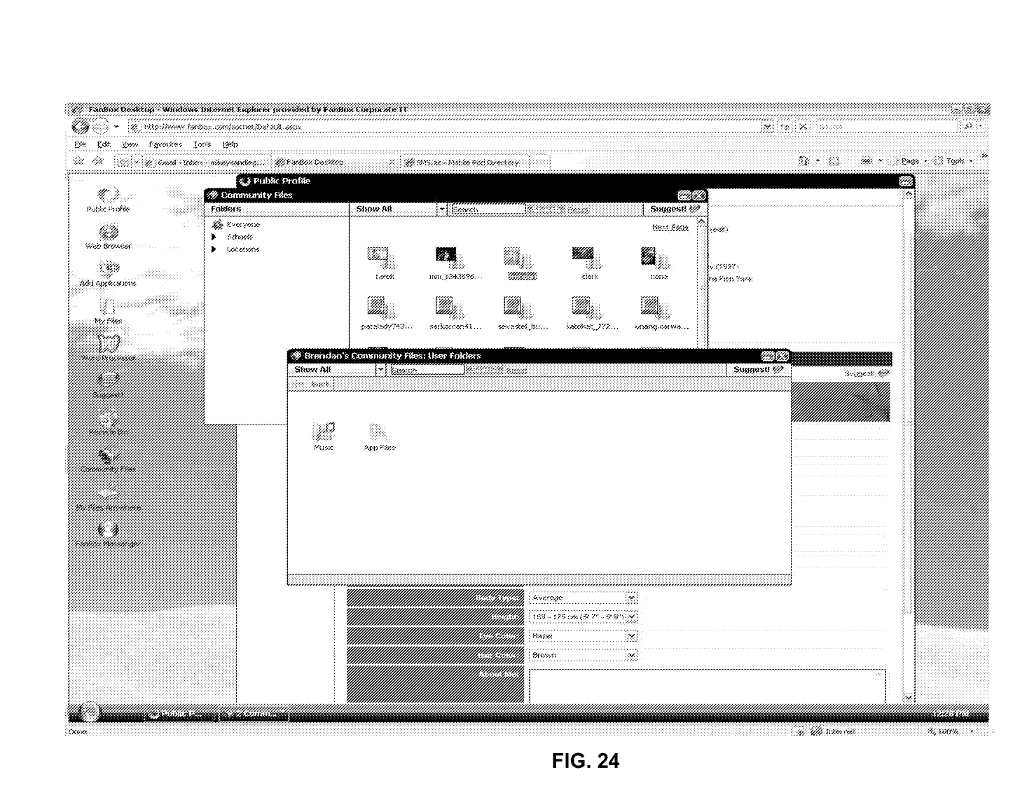

FIGS. 13-24 of the '040 application are example screen shots illustrating various capabilities and functionality that can be associated with mobile desktop 1100. FIGS. 24-35 of the '040 application are screen shots illustrating other applications and associated content that can be made available and accessed via mobile desktop 1100.

Thus, the mobile desktop can provide access to applications and content that are stored on, or accessed through platform 202 in a way that allows efficient interaction between the social content and of platform 202 and the applications and tools normally found on the desktop.

It will be understood that when the mobile desktop is accessed via a mobile device 1701-1703, the mobile desktop may need to be rendered in a manner that is specifically tailored for the associated device type; however, the ability to maintain all of the resources online can greatly extend the power and convenience of platform 202.

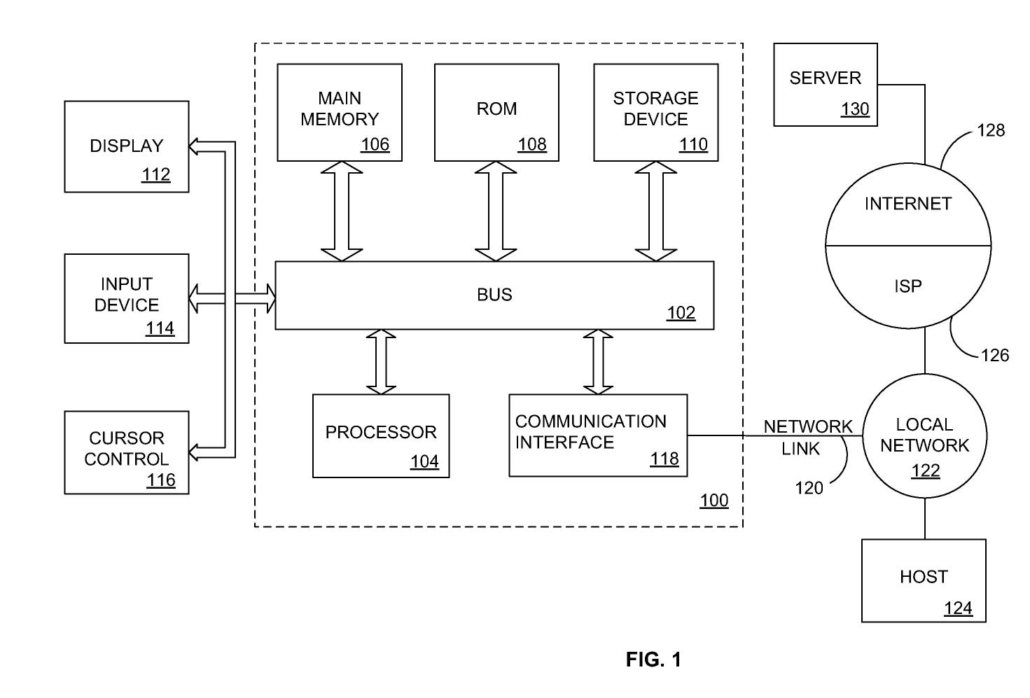

At least portions of the system and methods described herein can be implemented on or over a network such as the Internet. An example of such a network is described in FIG. 1. The description of the network and computer-based platforms that follows is exemplary. However, it should be clearly understood that the systems and methods described herein can be practiced without the specific details described herein. Well known structures and devices are shown in block diagram form in order to avoid unnecessarily obscuring the systems and methods described herein.

In certain embodiments, the user can download a synchronization program from platform 202 that can allow the user to synchronize their mobile desktop with their personal desktop. For example, the synchronization program can be configured to automatically upload all the user's documents, pictures, music, videos, etc., from the user's local hard drive to the mobile desktop. In other words, this content will be uploaded to an online storage area managed by platform 202 and made available to the user and the user's mobile desktop. In certain implementations, the user can specify whether the synchronization program should scan the user's entire computer, or whether only certain files or drives should be scanned. The synchronization program can then be run from the user's personal desktop periodically, and can even be configured to automatically run at certain intervals, e.g., every day, week, etc., or upon start up and/or power down.

In certain embodiments, the amount of online storage may be limited and/or provided for a certain cost. Thus, the user may go over their storage limit. In certain embodiments, the user can be prompted to add more storage, e.g., at a cost, in order to upload more content to the mobile desktop. In fact, a plurality of premium services can be added in this manner, i.e., the user can be prompted, either during installation or at some point thereafter to add some premium service, such as more storage, particular or enhanced applications, etc. Payment for these premium services can be handled via the billing processes described above.

Further, in certain embodiments, during the scanning process, the synchronization program can be configured to automatically create applications, i.e., pods or widgets, as it locates and uploads content. For example, as the synchronization program locates photos, it can create a photo album widget on the user's mobile desktop for viewing the photos. Similarly, widgets for videos, music, etc.

FIG. 1 is a block diagram that illustrates a computer system 100 upon which an embodiment can be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the systems and methods described herein. Thus, embodiments are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

Further description and illustration of the various embodiments of the invention described herein are provided in Appendices A attached hereto and incorporated herein by reference as if set forth in full.

Appendix A is a concept criteria document that describes the implementation of the various embodiments of mobile network community platform Application Programming Interface (API). As described within the document, the desktop API can be configured to allow an application to open and save a file on a logged in user's mobile desktop 1100. This functionality can be accomplished by embedding tags within the application to provide access to “open”/“save” dialogues.

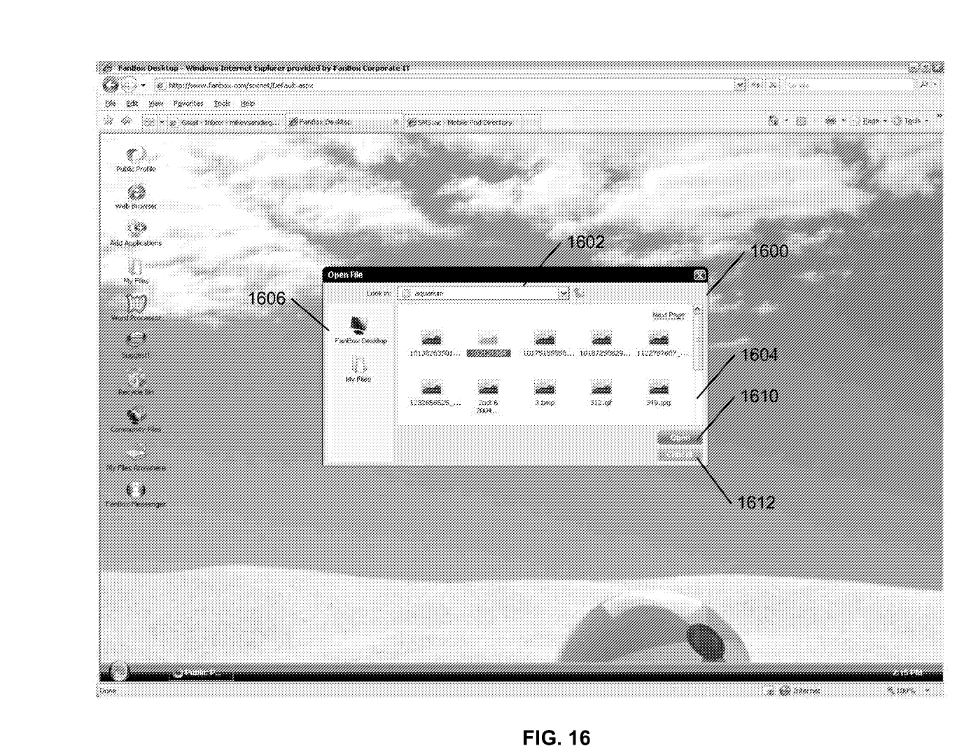

The desktop API can also be configured to allow an application to read and write files while within their own dedicated directory using a defined application file access logic as illustrated in FIGS. 16-24, which provide a series of concept screenshots that illustrate the various components and features that are described in Appendix A. The defined logic delineates a set of rules and internal logic that governs the application's ability to access files on the mobile desktop and the network community platform.

Furthermore, the desktop API can be configured to allow a file created by an application (using the desktop API) to be shared with other users who subscribe to the network community platform using a defined file share logic scheme illustrated in FIGS. 16-24 and described in appendix A. This file share logic scheme delineates a set of rules and internal logic that governs how a file that is created by the application using the desktop API can be stored, indexed and shared with other users who subscribe to the network community platform.

In other words, the API is a set of routines, data structures, object classes and/or protocols provided by libraries and/or operating system services in order to support the building of applications that can store documents and files on the mobile desktop, read/write documents and files on the mobile desktop, set sharing properties of documents and files, etc. By defining the API, developers can develop applications that can run on mobile desktop 1100

As illustrated in FIG. 16, when the user wants to access a certain type of file, e.g., a file associated with a certain type of application, a pop-up window 1600 can appear. Window 1600 can include a window 1602 that depicts the present file location and a window 1604 that illustrates the file sin that location. Window 1606 can also be included and can include short cuts to certain locations such as the mobile desktop or a special folder such as “My Files.” The navigation control 1608 can be used to navigate to different locations, or folders on the mobile desktop as illustrated in FIG. 17.

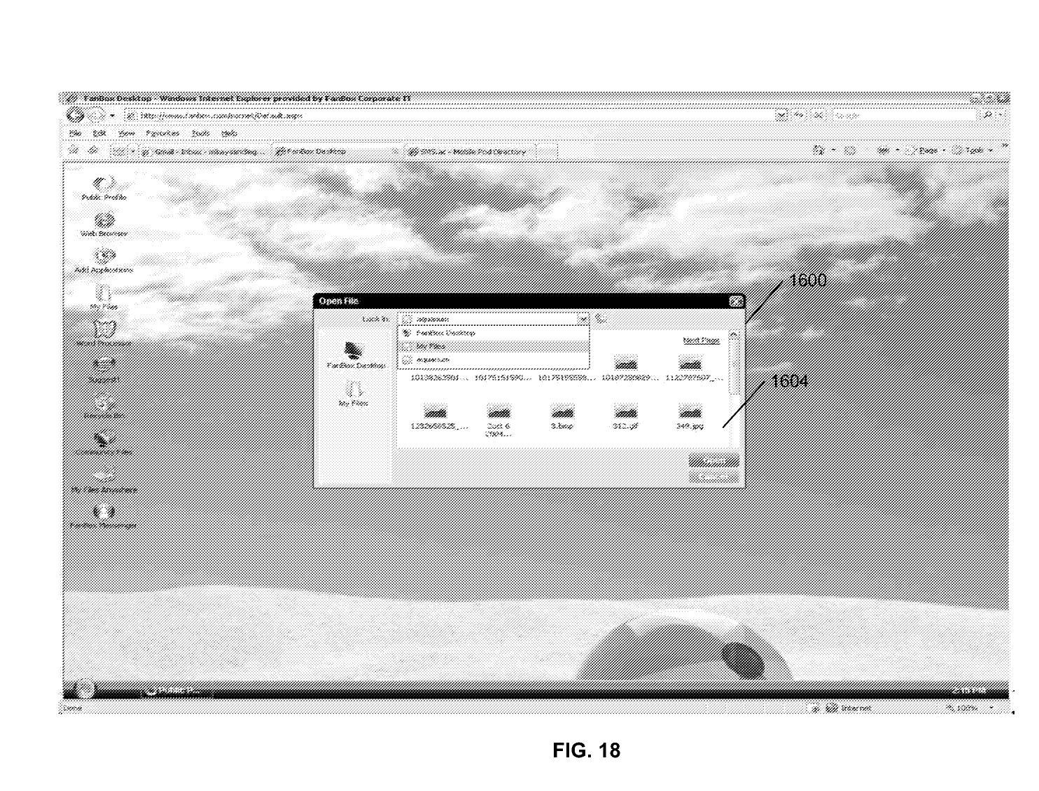

Double clicking on a file icon in window 1604 will cause the selected file to be passed to the associated program and will close window 1600. Similarly, clicking on “open” button 1610 when a file icon is highlighted will cause the highlighted file to be passed to the associated application. Clicking the “Cancel” button 1612 will also cause window 1600 to close. Double clicking the a folder icon will cause the display window 1604 to display the contents of the selected folder as illustrated in FIG. 18.

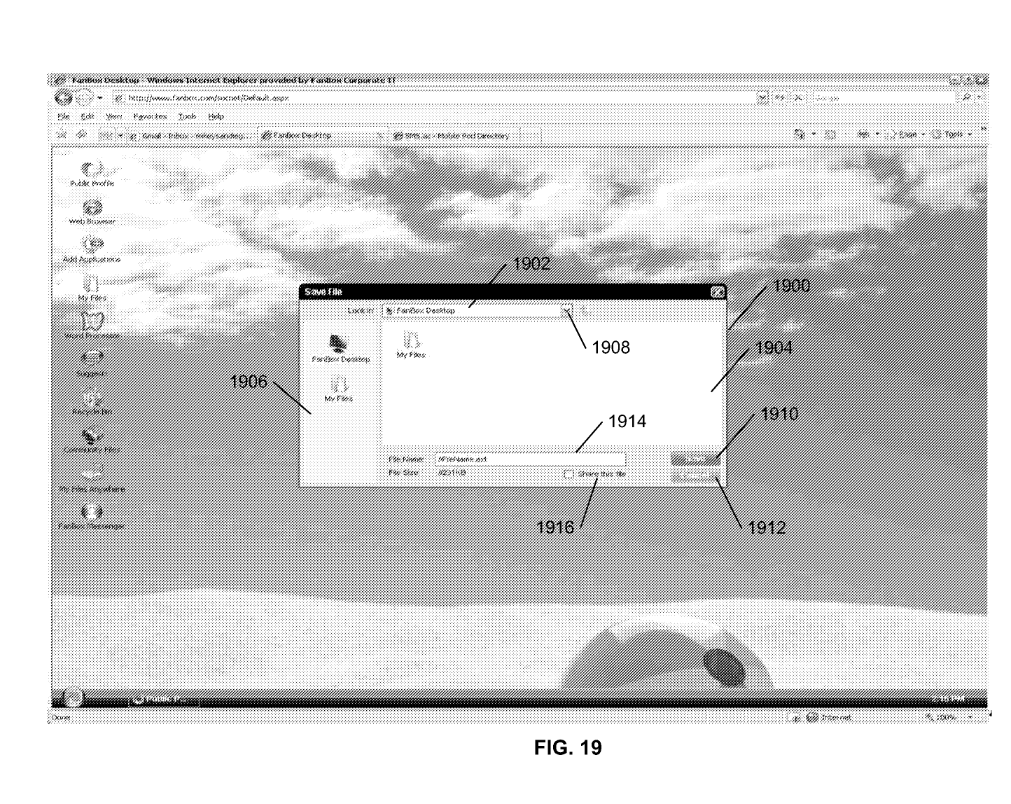

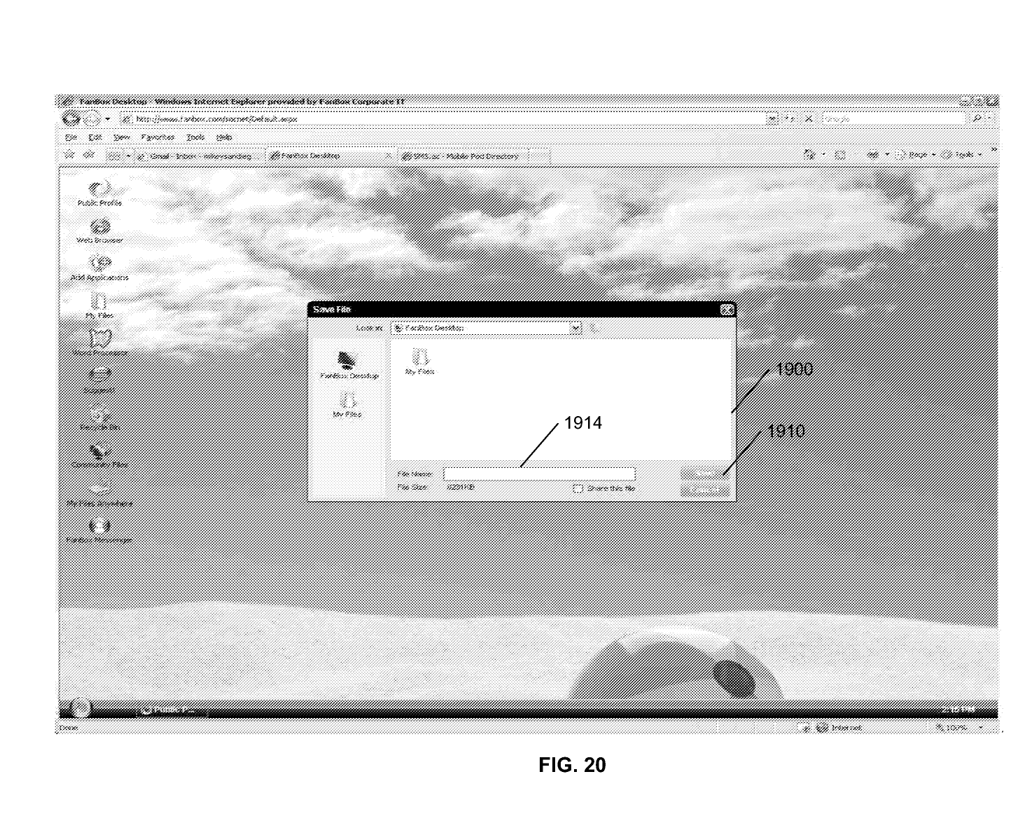

FIGS. 19-22 illustrate an example process for saving a file. As illustrated in FIG. 19, when an application attempts to save a file, a save file window 1900 will appear. Within this window 1900, window 1902 will depict the present location and window 1904 will depict the files and folders at that location. Location can be navigated using navigation control 1908, which will produce a drop down menu of files and folders. The name of the file will appear in window 1914. Clicking the “Save” button 1910 will cause the file to be saved at the present location and clicking the “Cancel” button 1912 will cause save file window 1900 to close. If the file name window 1914 is blank as illustrated in FIG. 20, then the “Save” button 1910 will appear disabled.

The share this file box 1916 can be used to set the share characteristics of eth file. If this box is checked, then the file can be available to those that have access to the user's mobile desktop as described above. The protocol for storing the file under these conditions is described in Appendix A.

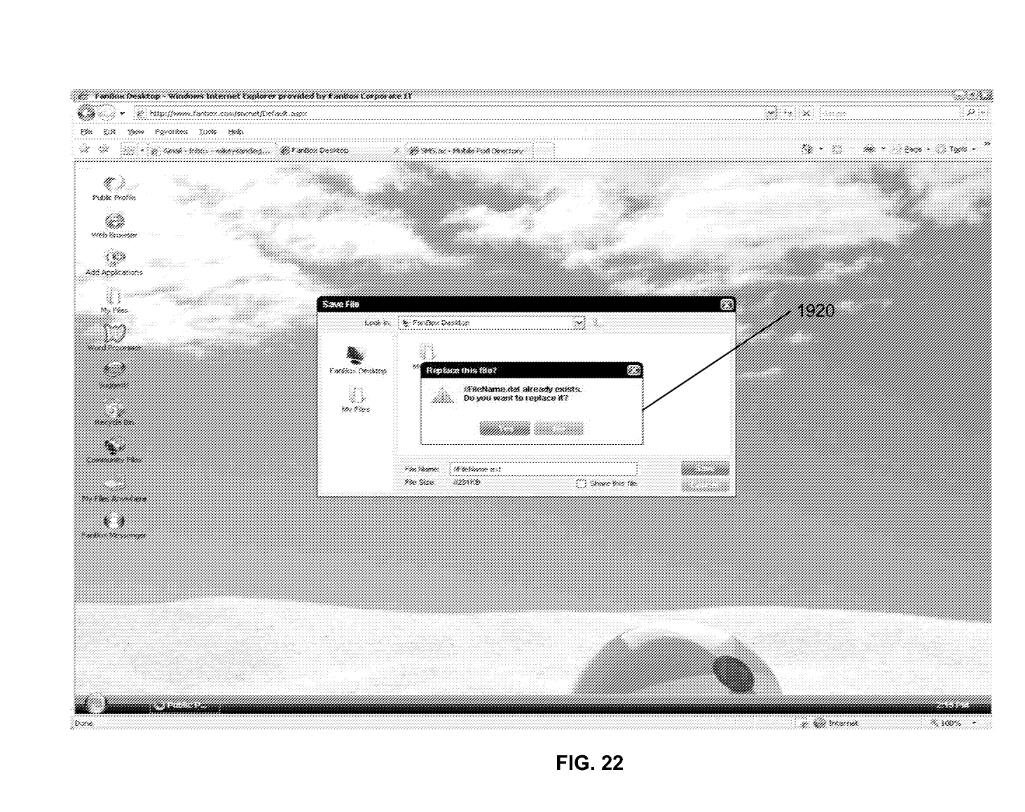

If there is already a file present in the same location with the same name as the file to be saved, then a replace file window 1920 can appear as illustrated in FIG. 22. The user can then proceed accordingly.

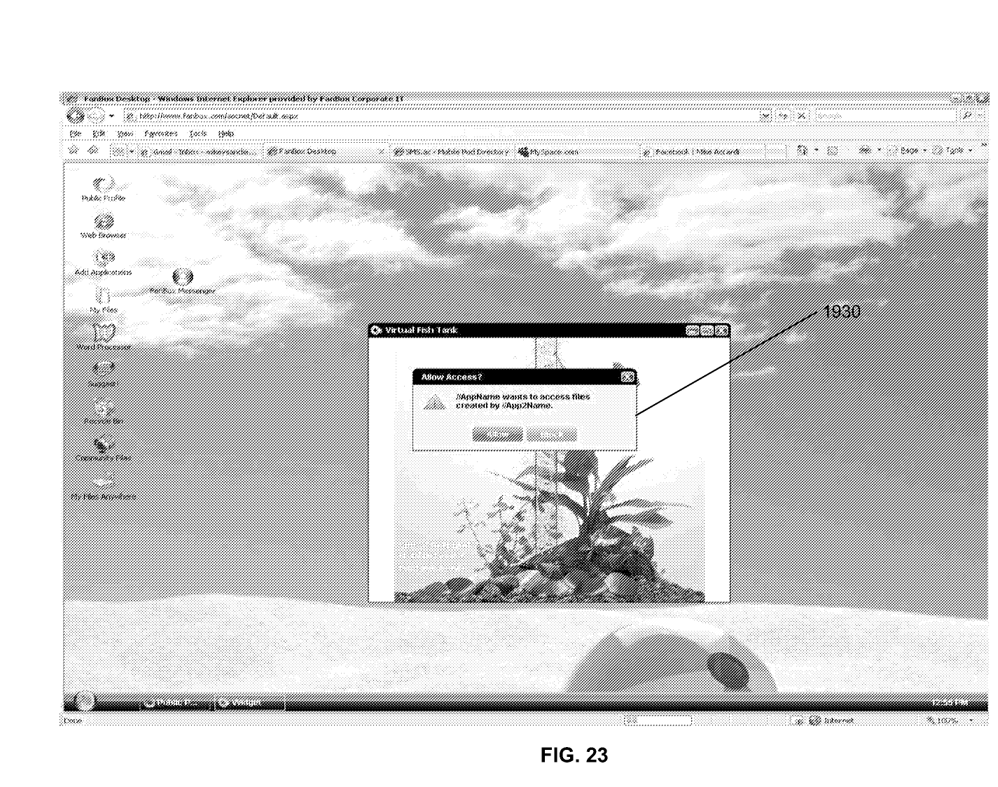

Generally, a third party application will have read only access to files in certain location on the mobile desktop, such as the desktop of the mobile desktop, or community file folders as illustrated in FIG. 24. An application can also have a file, folder, directory, etc., associated with the application. The Application can then have read/write access to files in these locations, If an application tries to access a file to which it does not have read or read/write access rights, then the allow access window 1930 can be generated as illustrated in FIG. 23. The user can then chose to allow or block access.

An application can also include a link to another application. Such a linked application will automatically have access to the linking application's files. If the linked application is not supported by the mobile desktop 1100, then access to the application will be blocked. A message, such as “invalid application name” can be shown to the user under such circumstances. In certain embodiments, if the user already owns the linked application, then accessing the link will cause the application to launch in the mobile desktop. If the user does not already own the application, then a prompt can appear asking the user if they want to own the application or, depending on the embodiment, the user can be opted into the application for free.

By defining an API that can allow third party applications to interface with and access files on the mobile desktop, a user can add increased functionality to the mobile desktop. The user can be charged to add such a program. Billing for the program can be handled as described above an in the related applications.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

APPENDIX A

| # | Requirement | | |
|---|---|---|---|
| | General Information | | General Information |
| 1 | This BRD describes the desktop API | n/a | General Information |
| 2 | It allows an application to | n/a | General Information |

| | | | |
|---|---|---|---|
| 3 | Open a file on a logged in user's mobile (i.e, FanBox) desktop | n/a | General Information |
| 4 | Save a file on a logged in user's mobile desktop | n/a | General Information |

| | | | |
|---|---|---|---|
| 5 | It allows an application to freely read/write files within their own dedicated directory, as | n/a | General Information |

described in:

| | | | |
|---|---|---|---|
| 6 | Application File Access Logic | n/a | General Information |

| 7 | When a file created by an application (using the Desktop API) is shared, follow File Share Logic | n/a | General Information |
|---|---|---|---|
| | Opening the prompts | | Opening the prompts |
| 8 | Within an xPML application the following tags provide access to open/save dialogs | n/a | Opening the prompts |
| 9 | <fbx open> | n/a | Opening the prompts |

| | | | |
|---|---|---|---|
| 10 | May be placed around | n/a | Opening the prompts |

| | | | |
|---|---|---|---|
| 11 | A button | n/a | Opening the prompts |
| 12 | A link | n/a | Opening the prompts |
| 13 | Any other user initiated action item | n/a | Opening the prompts |

| | | | |
|---|---|---|---|
| 14 | If this event is called | n/a | Opening the prompts |

| | | | |
|---|---|---|---|
| 15 | If the user is not logged in (guest mode) | n/a | Opening the prompts |

| | | | |
|---|---|---|---|
| 16 | Bring the SISU widget to the foreground | 11 | Opening the prompts |
| 17 | Display its sign-up mode | 11 | Opening the prompts |

| | | | |
|---|---|---|---|
| 18 | If the user is logged in: | n/a | Opening the prompts |

| | | | |
|---|---|---|---|
| 19 | If an open dialogue is already open, do nothing | 1 | Opening the prompts |
| 20 | Else pop up an Open Dialogue | 1 | Opening the prompts |

| | | | |
|---|---|---|---|
| 21 | <fbx saveas> | n/a | Opening the prompts |

| | | | |
|---|---|---|---|
| 22 | Optional Parameter: filename= | n/a | Opening the prompts |

| | | | |
|---|---|---|---|
| 23 | May be used to set the default file name within the save dialogue | n/a | Opening the prompts |

| | | | |
|---|---|---|---|
| 24 | Optional Parameter: shareon= | n/a | Opening the prompts |

| | | | |
|---|---|---|---|
| 25 | Boolean value used to indicate whether the save prompt should default to save on/off | n/a | Opening the prompts |
| 26 | Defaults to false, unless explicitly set to ‘true’ | n/a | Opening the prompts |

| | | | |
|---|---|---|---|
| 27 | May be placed around: | n/a | Opening the prompts |

| | | | |
|---|---|---|---|
| 28 | A button | n/a | Opening the prompts |
| 29 | A link | n/a | Opening the prompts |
| 30 | Any other user initiated action item | n/a | Opening the prompts |

| | | | |
|---|---|---|---|
| 31 | If this event is called: | n/a | Opening the prompts |

| | | | |
|---|---|---|---|
| 32 | If the user is not logged in (guest mode) | 11 | Opening the prompts |

| | | | |
|---|---|---|---|
| 33 | Bring the SISU widget to the foreground | 11 | Opening the prompts |
| 34 | Display its sign-up mode | 11 | Opening the prompts |

| | | | |
|---|---|---|---|
| 35 | If the user is logged in | 4 | Opening the prompts |

| | | | |
|---|---|---|---|
| 36 | If a save dialogue is already open, do nothing | 4 | Opening the prompts |
| 37 | Else pop up an Save Dialogue | 4 | Opening the prompts |

| | Open Dialogue | | Open Dialogue |
|---|---|---|---|
| 38 | Window title Open File | 1 | Open Dialogue |
| 39 | Attributes | 1 | Open Dialogue |

| | | | |
|---|---|---|---|
| 40 | Appears in the foreground | 1 | Open Dialogue |
| 41 | Is not draggable | 1 | Open Dialogue |
| 42 | Has no taskbar entry | 1 | Open Dialogue |

| | | | |
|---|---|---|---|
| 43 | Elements | 1 | Open Dialogue |

| | | | |
|---|---|---|---|
| 44 | Current location drop down | 1 | Open Dialogue |

| | | | |
|---|---|---|---|
| 45 | Will display the name of the location currently being viewed | 1 | Open Dialogue |

| | | | |
|---|---|---|---|
| 46 | If this name would exceed the width of the drop down, truncate it with an ellipsis | n/a | Open Dialogue |

or the right

| | | | |
|---|---|---|---|
| 47 | By default this drop down will be set to ‘FanBox Desktop’ | n/a | Open Dialogue |
| 48 | If the user is viewing a sub-folder (anything besides the desktop): | n/a | Open Dialogue |

| | | | |
|---|---|---|---|
| 49 | Clicking on the drop down will display a list of all folders starting from the | 2 | Open Dialogue |

current directory. and working upwards to the Desktop

| | | | |
|---|---|---|---|
| 50 | i.e, the desktop is considered to be the ‘root’ directory | 2 | Open Dialogue |

| | | | |
|---|---|---|---|
| 51 | Selecting a folder from the drop down will update the Display Area (described below) | 3 | Open Dialogue |

to display the contents of that folder

| | | | |
|---|---|---|---|
| 52 | QuickNav Side bar | n/a | Open Dialogue |

| | | | |
|---|---|---|---|
| 53 | Will include shortcuts to the logged in user's | 1 | Open Dialogue |

| | | | |
|---|---|---|---|
| 54 | FanBox desktop | 1 | Open Dialogue |
| 55 | My Files | 1 | Open Dialogue |

| | | | |
|---|---|---|---|
| 56 | The icons for each will serve as shortcuts | n/a | Open Dialogue |
| 57 | The text labels for each will serve as shortcuts | n/a | Open Dialogue |
| 58 | Clicking either shortcut will update the: | n/a | Open Dialogue |

| | | | |
|---|---|---|---|
| 59 | Display Area to display the contents of the clicked shortcut | n/a | Open Dialogue |
| 60 | Current location drop down to include the clicked shortcut's folder's name | n/a | Open Dialogue |

| | | | |
|---|---|---|---|
| 61 | Up Directory button | n/a | Open Dialogue |

| | | | |
|---|---|---|---|
| 62 | If the user is viewing their desktop, this button will: | n/a | Open Dialogue |

| | | | |
|---|---|---|---|
| 63 | Appear disabled | 4 | Open Dialogue |
| 64 | Clicking it will have no effect | 4 | Open Dialogue |

| | | | |
|---|---|---|---|
| 65 | If the user is viewing a sub-folder (anything besides the desktop): | n/a | Open Dialogue |

| | | | |
|---|---|---|---|
| 66 | Appear enabled | 1 | Open Dialogue |
| 67 | Clicking this button will update the: | n/a | Open Dialogue |

| 68 | Current location drop down to display the name of the current directory's | n/a | Open Dialogue |
|---|---|---|---|
| | parent folder | | |
| 69 | Display Area to display the contents of the current directory's parent folder | n/a | Open Dialogue |

| | | | |
|---|---|---|---|
| 70 | Display Area | 1 | Open Dialogue |

| | | | |
|---|---|---|---|
| 71 | Will display the icon view of the directory being displayed | 1 | Open Dialogue |
| 72 | Will not display Hidden Items | 1 | Open Dialogue |
| 73 | If there are more than 10 icons to display, display a scroll bar | 4 | Open Dialogue |
| 74 | If there are more than 50 icons, display pagination (same as on desktop) | 4 | Open Dialogue |
| 73 | Double clicking a folder icon in this area will: | n/a | Open Dialogue |

| | | | |
|---|---|---|---|
| 74 | Update the: | n/a | Open Dialogue |

| | | | |
|---|---|---|---|
| 75 | Current location drop down to include the double clicked folder's name | n/a | Open Dialogue |
| 76 | Display Area to display the contents of the double clicked directory | n/a | Open Dialogue |

| | | | |
|---|---|---|---|
| 77 | Double clicking a file icon in this area will: | n/a | Open Dialogue |

| | | | |
|---|---|---|---|
| 78 | Pass the file to the application | n/a | Open Dialogue |
| 79 | Close the Open Dialogue | n/a | Open Dialogue |

| | | | |
|---|---|---|---|
| 80 | Open button | n/a | Open Dialogue |

| | | | |
|---|---|---|---|
| 81 | If no file is highlighted in the Display Area: | n/a | Open Dialogue |

| | | | |
|---|---|---|---|
| 82 | The button will appear disabled | 2 | Open Dialogue |
| 83 | Clicking it will have no effect | 2 | Open Dialogue |

| | | | |
|---|---|---|---|
| 84 | If a file is highlighted in the Display Area | n/a | Open Dialogue |

| | | | |
|---|---|---|---|
| 85 | The button will appear enabled | 1 | Open Dialogue |
| 86 | Clicking it will | n/a | Open Dialogue |

| | | | |
|---|---|---|---|
| 87 | Pass the file to the application | n/a | Open Dialogue |
| 88 | Close the Open Dialogue | n/a | Open Dialogue |

| | | | |
|---|---|---|---|
| 89 | Cancel button | 1 | Open Dialogue |

| | | | |
|---|---|---|---|
| 90 | Clicking this button wi!l close the Open Dialogue | n/a | Open Dialogue |

| | | | |
|---|---|---|---|
| 91 | An [x] button | 1 | Open Dialogue |

| | | | |
|---|---|---|---|
| 92 | Clicking this button will close the Open Dialogue | n/a | Open Dialogue |

| | Save Dialogue | | Save Dialogue |
|---|---|---|---|
| 93 | Window title: Save File | 4 | Save Dialogue |
| 94 | Attributes: | 4 | Save Dialogue |

| | | | |
|---|---|---|---|
| 95 | Appears in the foreground | 4 | Save Dialogue |
| 96 | Is not draggable | 4 | Save Dialogue |
| 97 | Has no taskbar entry | 4 | Save Dialogue |

| | | | |
|---|---|---|---|
| 94 | Elements: | n/a | Save Dialogue |

| | | | |
|---|---|---|---|
| 95 | Current location drop down | 4 | Save Dialogue |

| | | | |
|---|---|---|---|
| 96 | Will display the name of the location currently being viewed | 4 | Save Dialogue |

| | | | |
|---|---|---|---|
| 97 | If this name would exceed the width of the drop down, truncate it with an ellipsis | n/a | Save Dialogue |

on the right

| | | | |
|---|---|---|---|
| 98 | By default, this drop down will be set to ‘FanBox Desktop’ | 4 | Save Dialogue |
| 99 | If the user is viewing a sub-folder (anything besides the desktop): | n/a | Save Dialogue |

| | | | |
|---|---|---|---|
| 100 | Clicking on the drop down will display a list of all folders starting from the | 2 | Save Dialogue |

current directory, and working upwards to the Desktop

| | | | |
|---|---|---|---|
| 101 | i.e., the desktop is considered to be the ‘root’ directory | 2 | Save Dialogue |

| | | | |
|---|---|---|---|
| 102 | Selecting a folder from the drop down will update the Display Area (described below) | 3 | Save Dialogue |

to display the contents of that folder

| | | | |
|---|---|---|---|
| 103 | QuickNav Side bar | 4 | Save Dialogue |

| | | | |
|---|---|---|---|
| 104 | Will include shortcuts to the logged in user's: | 4 | Save Dialogue |

| | | | |
|---|---|---|---|
| 105 | FanBox desktop | 4 | Save Dialogue |
| 106 | My Files | 4 | Save Dialogue |

| | | | |
|---|---|---|---|
| 107 | The icons for each will serve as shortcuts | n/a | Save Dialogue |
| 108 | The text labels for each will serve as shortcuts | n/a | Save Dialogue |
| 109 | Clicking either shortcut will update the | n/a | Save Dialogue |

| | | | |
|---|---|---|---|
| 110 | Display Area to display the contents of the clicked shortcut | n/a | Save Dialogue |
| 111 | Current location drop down to include the clicked shortcut's folder's name | n/a | Save Dialogue |

| | | | |
|---|---|---|---|
| 112 | Up Directory button | n/a | Save Dialogue |

| | | | |
|---|---|---|---|
| 113 | If the user is viewing their desktop, this button will: | n/a | Save Dialogue |

| | | | |
|---|---|---|---|
| 114 | Appear disabled | 4 | Save Dialogue |
| 115 | Clicking it will have no effect | 4 | Save Dialogue |

| | | | |
|---|---|---|---|
| 116 | If the user is viewing a sub-folder (anything besides the desktop): | n/a | Save Dialogue |

| | | | |
|---|---|---|---|
| 117 | Appear enabled | 3 | Save Dialogue |
| 118 | Clicking this button will update the | n/a | Save Dialogue |

| 119 | Current location drop down to display the name of the current directory's | n/a | Save Dialogue |
|---|---|---|---|
| | parent folder | | |
| 120 | Display Area to display the contents of the current directory's parent folder | n/a | Save Dialogue |

| | | | |
|---|---|---|---|
| 121 | Share toggle | 4 | Save Dialogue |

| | | | |
|---|---|---|---|
| 122 | If specified on method call, check this box | n/a | Save Dialogue |

| | | | |
|---|---|---|---|
| 123 | Else default to unchecked | 4 | Save Dialogue |

| | | | |
|---|---|---|---|
| 124 | If share text or help icon are moused over, display tooltip | 5b | Save Dialogue |
| 125 | Onmouseoff, hide tooltip | 5 | Save Dialogue |

| | | | |
|---|---|---|---|
| 126 | Display Area | n/a | Save Dialogue |

| | | | |
|---|---|---|---|
| 127 | Will display the icon view of the directory being displayed | 4 | Save Dialogue |
| 128 | Will not display Hidden Items | 4 | Save Dialogue |
| 129 | If there are more than 10 icons to display, display a scroll bar | 4 | Save Dialogue |
| 130 | If there are more than 50 icons, display pagination (same as on desktop) | 4 | Save Dialogue |
| 131 | Double clicking a folder icon in this area will. | n/a | Save Dialogue |

| | | | |
|---|---|---|---|
| 132 | Update the: | n/a | Save Dialogue |

| | | | |
|---|---|---|---|
| 133 | Current location drop down to include the double clicked folder's name | n/a | Save Dialogue |
| 134 | Display Area to display the contents of the double clicked directory | n/a | Save Dialogue |

| | | | |
|---|---|---|---|
| 135 | Double clicking a file icon in this area will | n/a | Save Dialogue |

| | | | |
|---|---|---|---|
| 136 | Have no effect | n/a | Save Dialogue |

| | | | |
|---|---|---|---|
| 137 | File Name field | n/a | Save Dialogue |

| | | | |
|---|---|---|---|
| 138 | If the <fbx:saveas> tag included the filename parameter, populate the field with that value | 4 | Save Dialogue |
| 139 | Else, the field will be blank | 5 | Save Dialogue |
| 140 | Will allow the user to specify the name of the file to be saved | n/a | Save Dialogue |

| | | | |
|---|---|---|---|
| 141 | File Size indicator | n/a | Save Dialogue |

| 142 | Will indicate the size of the file to be saved | 4 | Save Dialogue |
|---|---|---|---|
| 143 | If the file is less than 1KB, display ‘1KB’ | n/a | Save Dialogue |
| 144 | If the file > 1KB and file <1024KB, display ‘XKB’, where X is the number of | 4 | Save Dialogue |
| | bytes in the file | | |
| 145 | If the file > 1024KB and file <1024MB, display ‘XMB’, where: | n/a | Save Dialogue |

| | | | |
|---|---|---|---|
| 146 | X is the number of megabytes in the file | n/a | Save Dialogue |
| 147 | The level of precision will be one decimal place | n/a | Save Dialogue |

| | | | |
|---|---|---|---|
| 148 | I.e., show 1.5MB, not “1MB” for a 1536KB size file | n/a | Save Dialogue |

| | | | |
|---|---|---|---|
| 149 | Save button | 4 | Save Dialogue |

| | | | |
|---|---|---|---|
| 150 | If the File Name field is blank: | 5 | Save Dialogue |

| | | | |
|---|---|---|---|
| 151 | The button will appear disabled | 5 | Save Dialogue |
| 152 | Clicking it will have no effect | 5 | Save Dialogue |

| | | | |
|---|---|---|---|
| 153 | If the File Name field has a value: | 4 | Save Dialogue |

| | | | |
|---|---|---|---|
| 154 | If a file with that same name does not exist in the current directory displayed in | n/a | Save Dialogue |

the Display Area:

| | | | |
|---|---|---|---|
| 155 | Save the file to that directory | n/a | Save Dialogue |
| 156 | If Share Toggle set to true, share the file according to File Share Logic | n/a | Save Dialogue |

| | | | |
|---|---|---|---|
| 157 | Else do not share the file | n/a | Save Dialogue |

| | | | |
|---|---|---|---|
| 158 | Close the Save Dialogue | n/a | Save Dialogue |

| | | | |
|---|---|---|---|
| 159 | If a file with that same name exists in the current directory displayed in the | n/a | Save Dialogue |

Display Area:

| | | | |
|---|---|---|---|
| 160 | Display a Replace File Prompt | 6 | Save Dialogue |

| | | | |
|---|---|---|---|
| 161 | Cancel button | 4 | Save Dialogue |

| | | | |
|---|---|---|---|
| 162 | Clicking this button will close the Save Dialogue | n/a | Save Dialogue |

| | | | |
|---|---|---|---|
| 163 | An [x] button | 4 | Save Dialogue |

| | | | |
|---|---|---|---|
| 164 | Clicking this button will close the Save Dialogue | n/a | Save Dialogue |

| | Replace File Prompt | | Replace File Prompt |
|---|---|---|---|
| 165 | Attributes. | 6 | Replace File Prompt |

| | | | |
|---|---|---|---|
| 166 | Appears in the foreground (above the Save Dialogue) | 6 | Replace File Prompt |
| 167 | Is not draggable | 6 | Replace File Prompt |
| 168 | Has no taskbar entry | 6 | Replace File Prompt |

| | | | |
|---|---|---|---|
| 169 | Window title. Replace this file? | 6 | Replace File Prompt |
| 170 | Elements | 6 | Replace File Prompt |

| | | | |
|---|---|---|---|
| 171 | The name of the file about to be replaced | 6 | Replace File Prompt |

| | | | |
|---|---|---|---|
| 172 | If this name would exceed the widtn of the window, truncate it with an ellipsis | n/a | Replace File Prompt |

| | | | |
|---|---|---|---|
| 173 | Yes button | 6 | Replace File Prompt |

| | | | |
|---|---|---|---|
| 174 | Clicking this button will: | n/a | Replace File Prompt |

| | | | |
|---|---|---|---|
| 175 | Save over the current file | n/a | Replace File Prompt |
| 176 | Close the Replace File Prompt | n/a | Replace File Prompt |
| 177 | Close the Save Dialogue | n/a | Replace File Prompt |

| | | | |
|---|---|---|---|
| 178 | No button | 6 | Replace File Prompt |

| | | | |
|---|---|---|---|
| 179 | Clicking this button will: | n/a | Replace File Prompt |

| | | | |
|---|---|---|---|
| 180 | Close the Replace File Prompt | n/a | Replace File Prompt |

| | | | |
|---|---|---|---|
| 181 | An [x] button | 6 | Replace File Prompt |

| | | | |
|---|---|---|---|
| 182 | Clicking this button will: | n/a | Replace File Prompt |

| | | | |
|---|---|---|---|
| 183 | Close the Replace File Prompt | n/a | Replace File Prompt |

| | Hidden Items | | Hidden Items |
|---|---|---|---|
| 184 | The following items will not be shown within the display area | n/a | Hidden Items |

| | | | |
|---|---|---|---|
| 185 | Shortcut to | n/a | Hidden Items |

| | | | |
|---|---|---|---|
| 186 | Public Profile | n/a | Hidden Items |
| 187 | Web Browser | n/a | Hidden Items |
| 188 | Add Applications | n/a | Hidden Items |
| 189 | Word Processor | n/a | Hidden Items |
| 190 | Suggest! | n/a | Hidden Items |
| 191 | Recycle Bin | n/a | Hidden Items |
| 192 | My Files Anywhere | n/a | Hidden Items |
| 193 | FanBox Messenger | n/a | Hidden Items |

| | File Share Logic | | File Share Logic |
|---|---|---|---|
| 194 | When a file created by a 3rd party application is shared, it should appear in the community files | 8 | File Share Logic |

under:

| | | | |
|---|---|---|---|
| 195 | //userName/App Flies/Application Name/File Name | 8 | File Share Logic |
| 196 | Where: | n/a | File Share Logic |

| | | | |
|---|---|---|---|
| 197 | userName is the displayName of the person who is sharing the file | 9 | File Share Logic |
| 198 | A directory will be shown with the application's name as its title | 9 | File Share Logic |

| | | | |
|---|---|---|---|
| 199 | This name will be truncated with an ellipsis if it would exceed 35 characters | n/a | File Share Logic |

| | | | |
|---|---|---|---|
| 200 | Inside this directory will be all shared files created by //ApplicationName | n/a | File Share Logic |

| | | | |
|---|---|---|---|
| 201 | Folders within the App Files directory will be sorted alphabetically | 9 | File Share Logic |
| 202 | These folders will have a custom icon | 8, 9 | File Share Logic |

| | Application File Access Logic | | Application File |
|---|---|---|---|
| | | | Access Logic |
| 203 | An application will have read-only access to | n/a | Application File |

| | | | Access Logic |
|---|---|---|---|
| 204 | The application owner's files on their FanBox desktop | n/a | Application File |
| | | | Access Logic |
| 205 | Any files accessible to the application owner view Community Files | n/a | Application File |

| | | | Access Logic |
|---|---|---|---|
| 206 | By default the current directory is the ApplicationDirectory | n/a | Application File |

| | | | Access Logic |
|---|---|---|---|
| 207 | ApplicationDirectory attributes: | n/a | Application File |

| | | | Access Logic |
|---|---|---|---|
| 208 | Name = the application's name | n/a | Application File |
| | | | Access Logic |
| 209 | Location = the application owner's My Files > App Files > Application Directory | n/a | Application File |
| | | | Access Logic |
| 210 | if this directory does not exist at the time any of these methods are called, create it | n/a | Application File |
| | immediately | | Access Logic |

| | | | |
|---|---|---|---|
| 211 | The user will not be able to rename this directory | n/a | Application File |

| | | | Access Logic |
|---|---|---|---|
| 212 | Definition: RootDirectory = the user's FanBox desktop | n/a | Application File |

| | | | Access Logic |
|---|---|---|---|
| 213 | The following are subdirectories of the RootDirectory: | n/a | Application File |

| | | | Access Logic |
|---|---|---|---|
| 214 | Community Files | n/a | Application File |
| | | | Access Logic |
| 215 | My Files | n/a | Application File |
| | | | Access Logic |
| 216 | Any user created folders | n/a | Application File |

| | | | Access Logic |
|---|---|---|---|
| 217 | An application can traverse these directories via the methods below | n/a | Application File |

| | | | Access Logic |
|---|---|---|---|
| 218 | LS | n/a | Application File |

| | | | Access Logic |
|---|---|---|---|
| 219 | Parameters n/a | n/a | Application File |
| | | | Access Logic |
| 220 | Returns a comma delimited list of all files in the current directory | n/a | Application File |

| | | | Access Logic |
|---|---|---|---|
| 221 | CD | n/a | Application File |

| | | | Access Logic |
|---|---|---|---|
| 222 | Parameters: String: DirectoryName \| ../ | n/a | Application File |
| | | | Access Logic |
| 223 | If called with ../ | n/a | Application File |

| | | | Access Logic |
|---|---|---|---|
| 224 | If the current directory is not the root (user's desktop): | n/a | Application File |

| | | | Access Logic |
|---|---|---|---|
| 225 | Change the directory to the current folder's parent folder | n/a | Application File |
| | | | Access Logic |
| 226 | Return true | n/a | Application File |

| | | | Access Logic |
|---|---|---|---|
| 227 | If the current directory is the root (user's desktop): | n/a | Application File |

| | | | Access Logic |
|---|---|---|---|
| 228 | Return false | n/a | Application File |

| | | | Access Logic |
|---|---|---|---|
| 229 | Else If DirectoryName exists within the current directory | n/a | Application File |

| | | | Access Logic |
|---|---|---|---|
| 230 | Changes the current driectory to Director/Name | n/a | Application File |
| | | | Access Logic |
| 231 | Return true | n/a | Application File |

| | | | Access Logic |
|---|---|---|---|
| 232 | Else return false | n/a | Application File |

| | | | Access Logic |
|---|---|---|---|
| 233 | GET | n/a | Application File |

| | | | Access Logic |
|---|---|---|---|
| 234 | Parameters. String: FileName | n/a | Application File |
| | | | Access Logic |
| 235 | If FileName is not specified return false | n/a | Application File |
| | | | Access Logic |
| 236 | Else: | n/a | Application File |

| | | | Access Logic |
|---|---|---|---|
| 237 | If the current directory does not belong to another application | n/a | Application File |

| | | | Access Logic |
|---|---|---|---|
| 238 | If FileName exists within the current directory | n/a | Application File |

| | | | Access Logic |
|---|---|---|---|
| 239 | Returns a byte stream of FileName | n/a | Application File |

| | | | Access Logic |
|---|---|---|---|
| 240 | Else, returns false | n/a | Application File |

| | | | Access Logic |
|---|---|---|---|
| 241 | Else if the current directory belongs to another application: | n/a | Application File |

| | | | Access Logic |
|---|---|---|---|
| 242 | If this application is not marked as having access to the other application's | n/a | Application File |
| | files: | | Access Logic |

| 243 | Display the Application Access Prompt to the user | n/a | Application File |
|---|---|---|---|
| | | | Access Logic |
| 244 | Return ‘Access Denied’ error | n/a | Application File |

| | | | Access Logic |
|---|---|---|---|
| 245 | If this application is marked as having access to the other application's | n/a | Application File |
| | files: | | Access Logic |

| | | | |
|---|---|---|---|
| 246 | If FileName exists within the current directory: | n/a | Application File |

| | | | Access Logic |
|---|---|---|---|
| 247 | Returns a byte stream of FileName | n/a | Application File |

| | | | Access Logic |
|---|---|---|---|
| 248 | Else, returns false | n/a | Application File |

| | | | Access Logic |
|---|---|---|---|
| 249 | MKDIR | n/a | Application File |

| | | | Access Logic |
|---|---|---|---|
| 250 | Parameters: String: FolderName | n/a | Application File |
| | | | Access Logic |
| 251 | If the current folder is a sub-directory of the application's folder, or the | n/a | Application File |
| | application folder itself: | | Access Logic |

| | | | |
|---|---|---|---|
| 252 | If FolderName does not already exist in the current directory | n/a | Application File |

| | | | Access Logic |
|---|---|---|---|
| 253 | Create a folder with the name FolderName | n/a | Application File |
| | | | Access Logic |
| 254 | Return true | n/a | Application File |

| | | | Access Logic |
|---|---|---|---|
| 255 | If FolderName already exists in the current directory | n/a | Application File |

| | | | Access Logic |
|---|---|---|---|
| 256 | Return ‘Folder already exists’ error | n/a | Application File |

| | | | Access Logic |
|---|---|---|---|
| 257 | If the current folder is not a sub-directory of the application's folder and is not | n/a | Application File |
| | the application folder itself | | Access Logic |

| | | | |
|---|---|---|---|
| 258 | Return ‘Access Denied’ error | n/a | Application File |

| | | | Access Logic |
|---|---|---|---|
| 259 | RM | n/a | Application File |

| | | | Access Logic |
|---|---|---|---|
| 260 | Parameters String. FolderName/FileName | n/a | Application File |
| | | | Access Logic |
| 261 | If the current folder is a sub-directory of the application's folder, or the | n/a | Application File |
| | application folder itself: | | Access Logic |

| | | | |
|---|---|---|---|
| 262 | If FolderName/FileName does not already exist in the current directory: | n/a | Application File |

| | | | Access Logic |
|---|---|---|---|
| 263 | Return ‘File does not exist’ error | n/a | Application File |

| | | | Access Logic |
|---|---|---|---|
| 264 | If FolderName/FileName already exists in the current directory: | n/a | Application File |

| | | | Access Logic |
|---|---|---|---|
| 265 | Delete the File/Folder | n/a | Application File |
| | | | Access Logic |
| 266 | Return true | n/a | Application File |

| | | | Access Logic |
|---|---|---|---|
| 267 | If the current folder is not a sub-directory of the application's folder and is not | n/a | Application File |
| | the application folder itself | | Access Logic |

| | | | |
|---|---|---|---|
| 268 | Return ‘Access Denied’ error | n/a | Application File |

| | | | Access Logic |
|---|---|---|---|
| 269 | PUT | n/a | Application File |

| | | | Access Logic |
|---|---|---|---|
| 270 | Parameters String: URL, String: FileName | n/a | Application File |
| | | | Access Logic |
| 271 | If URL and/or FileName are null, return false | n/a | Application File |
| | | | Access Logic |
| 272 | Else | n/a | Application File |

| | | | Access Logic |
|---|---|---|---|
| 273 | If the current folder is a sub-directory of the application's folder, or the | n/a | Application File |
| | application folder itself: | | Access Logic |

| | | | |
|---|---|---|---|
| 274 | If FolderName/FileName does not already exist in the current directory: | n/a | Application File |

| | | | Access Logic |
|---|---|---|---|
| 275 | Upload URL to the current directory, with FileName as the file name | n/a | Application File |
| | | | Access Logic |
| 276 | Return true | n/a | Application File |

| | | | Access Logic |
|---|---|---|---|
| 277 | If FolderName/FileName already exists in the current directory: | n/a | Application File |

| | | | Access Logic |
|---|---|---|---|
| 278 | Upload URL to the current directory, with FileName as the file name, | n/a | Application File |
| | replacing the current file | | Access Logic |
| 279 | Return true | n/a | Application File |

| | | | Access Logic |
|---|---|---|---|
| 280 | If the current folder is not a sub-directory of the application's folder and is | n/a | Application File |
| | not the application folder itself: | | Access Logic |

| | | | |
|---|---|---|---|
| 281 | Return ‘Access Denied’ error | n/a | Application File |

| | | | Access Logic |
|---|---|---|---|
| | Application Access Prompt | | Application Access |
| | | | Prompt |
| 282 | Attributes | 7 | Application Access |

| | | | Prompt |
|---|---|---|---|
| 283 | Appears in tne foreground (above any Open/Save Dialogues) | 7 | Application Access |
| | | | Prompt |
| 284 | Is not draggable | 7 | Application Access |
| | | | Prompt |
| 285 | Has no taskbar entry | 7 | Application Access |

| | | | Prompt |
|---|---|---|---|
| 286 | Window title: Allow Access? | 7 | Application Access |
| | | | Prompt |
| 287 | Elements: | 7 | Application Access |

| | | | Prompt |
|---|---|---|---|
| 288 | Text asking if the user wants to allow ApplicationA to read ApplicationB's files | 7 | Application Access |

| | | | Prompt |
|---|---|---|---|
| 289 | ApplicationA is the application attempting to read the files | n/a | Application Access |
| | | | Prompt |
| 290 | ApplicationB is the application whose files are attempting to be read by another app | n/a | Application Access |
| | | | Prompt |
| 291 | For each application, if the name is longer than 25 characters truncate it with an | 7b | Application Access |
| | ellipsis | | Prompt |

| | | | |
|---|---|---|---|
| 292 | Allow button | 7 | Application Access |

| | | | Prompt |
|---|---|---|---|
| 293 | Clicking this button will: | n/a | Application Access |

| | | | Prompt |
|---|---|---|---|
| 294 | Grant ApplicationA permanent read-only access to ApplicationB's files | n/a | Application Access |
| | | | Prompt |
| 295 | Close the Application Access Prompt | n/a | Application Access |

| | | | Prompt |
|---|---|---|---|
| 296 | Block button | 7 | Application Access |

| | | | Prompt |
|---|---|---|---|
| 297 | Clicking this button will: | n/a | Application Access |

| | | | Prompt |
|---|---|---|---|
| 298 | Block ApplicationA from reading ApplicationB's files | n/a | Application Access |
| | | | Prompt |
| 299 | Close the Application Access Prompt | n/a | Application Access |

| | | | Prompt |
|---|---|---|---|
| 300 | An [x] button | 7 | Application Access |

| | | | Prompt |
|---|---|---|---|
| 301 | Clicking this button will: | n/a | Application Access |

| | | | Prompt |
|---|---|---|---|
| 302 | Block ApplicationA from reading ApplicationB's files | n/a | Application Access |
| | | | Prompt |
| 303 | Close the Application Access Prompt | n/a | Application Access |

| | | | Prompt |
|---|---|---|---|
| | Application Linking | | Application Linking |
| 304 | An application can embed a link to another application | n/a | Application Linking |
| 305 | This link will be defined by the following | n/a | Application Linking |

| | | | |
|---|---|---|---|
| 306 | <fbx.applink> | n/a | Application Linking |

| | | | |
|---|---|---|---|
| 307 | Parameters: String. ApplicationName, String: PageTarget | n/a | Application Linking |
| 308 | ApplicationName specifies the application to be opened when this link is clicked | n/a | Application Linking |
| 309 | PageTarget specifies a parameter to be passed via the QueryString to the application | n/a | Application Linking |

being linked to

| 310 | If ApplicationName is not recognized as being an active FanBox application, return an | n/a | Application Linking |
|---|---|---|---|
| | ‘Invalid application name’ error | | |
| 311 | If ApplicationName is recognized as being an active FanBox application: | n/a | Application Linking |

| | | | |
|---|---|---|---|
| 312 | If a user clicks on this link | n/a | Application Linking |

| | | | |
|---|---|---|---|
| 313 | If the user owns the application being linked to. | n/a | Application Linking |

| 314 | The application will appear in double wide view | n/a | Application Linking |
|---|---|---|---|
| 315 | It will be popped out on the user's desktop | n/a | Application Linking |
| 316 | It will be in the foreground | n/a | Application Linking |
| 317 | On load, it will be passed (via the query string) any PageTarget value that had been | n/a | Application Linking |
| | specified | | |
| 318 | The linked-to application will automatically be marked as having access to the | n/a | Application Linking |

calling application's files

| | | | |
|---|---|---|---|
| 319 | If the user does not own the application being linked to | n/a | Application Linking |

| | | | |
|---|---|---|---|
| 320 | If the application being linked to is Tier 1 and not one of the user's first six | n/a | Application Linking |

apps:

| | | | |
|---|---|---|---|
| 321 | Display the appropriate step of optin | n/a | Application Linking |
| 322 | If the user completes optin succesfully: | n/a | Application Linking |

| 323 | The application will appear in double wide view | n/a | Application Linking |
|---|---|---|---|
| 324 | It will be popped out on the user's desktop | n/a | Application Linking |
| 325 | It will be in the foreground | n/a | Application Linking |
| 326 | On load it will be passed (via the query string) any PageTarget value that | n/a | Application Linking |
| | had been specified | | |
| 327 | The linked-to application will automatically be marked as having access to | n/a | Application Linking |

the calling application's files

| | | | |
|---|---|---|---|
| 328 | Else, return a ‘Application not added’ status message | n/a | Application Linking |

| | | | |
|---|---|---|---|
| 329 | Else: | n/a | Application Linking |

| 330 | Opt the user into the application for free | n/a | Application Linking |
|---|---|---|---|
| 331 | The application will appear in double wide view | n/a | Application Linking |
| 332 | It will be popped out on the user's desktop | n/a | Application Linking |
| 333 | It will be in the foreground | n/a | Application Linking |
| 334 | On load, it will be passed (via the query string) any PageTarget value that had been | n/a | Application Linking |
| | specified | | |
| 335 | The linked-to application will automatically be marked as having access to the | n/a | Application Linking |

calling application's files

Business Objective: (WHY) To allow applications to tap into our mobile desktop, and thus exploit our primary differentiation over our competitors. This will increase the number of developers using our platform, and thus the variety, and quality of applications. This will increase retention and revenue.

What is claimed:

1. A network platform for supporting a network-enabled application, comprising a plurality of communication channels to respective plurality of wireless network carries, each of the wireless network carriers having a plurality of users, the network platform comprising;
at least one processor;
at least one interface having access to the internet;
a mobile desktop applications;
at least one third party online application;
at least one file stored on the mobile desktop;
a online operating system defining one or more sequences of instructions for integrating access to the third party online application and the network application via the mobile desktop application; and
an Application Programming Interface (API) defining one or more sequences of instructions for allowing a third party online application to operate with the mobile desktop to save, read, and write files, wherein execution of the one or more sequences of instructions by the processor causes the processor to:
receive a request from the third party online application to access a file stored on the mobile desktop,
determine whether the third party online application has access right to the requested file, and
allow the third party online application access to the requested file when it is determined that the third party online application has access rights to the requested file.

2. The network platform of claim 1, wherein the execution of the one or more sequences of instructions by the processor further causes the processor to deny access to the requested file when it is determined that the third party online application does not have access rights to the requested file.

3. The network platform of claim 1, the execution of the one or more sequences of instructions by the processor further causes the processor to generate a prompt when it is when it is determined that the third party online application does not have access rights to the requested file, wherein the prompt indicates the third party online application is attempting to access a file to which it does not have access rights.

4. The network platform of claim 3, wherein the execution of the one or more sequences of instructions by the processor further causes the processor to receive an instruction allowing access to the requested file by the third party online application in response to the prompt.

5. The network platform of claim 3, wherein the execution of the one or more sequences of instructions by the processor further causes the processor to receive an instruction denying access to the requested file by the third party online application in response to the prompt.

6. The network platform of claim 1, wherein the execution of the one or more sequences of instructions by the processor further causes the processor to pass the requested file to the third party online application when access to the requested file is allowed.

7. The network platform of claim 1, wherein the third party online application includes a link to another online application, and wherein the execution of the one or more sequences of instructions by the processor further causes the processor to receive a request for access to the other online application via the link.

8. The network platform of claim 7, wherein the execution of the one or more sequences of instructions by the processor further causes the processor to determine whether the other online application is supported by the mobile desktop and when it is determined that the other online application is supported, allowing access to the other online application in response to the received request.

9. The network platform of claim 7, wherein the execution of the one or more sequences of instructions by the processor further causes the processor to determine whether the requesting user owns the other online application and when it is determined that the user owns the other online application, allowing access to the other online application in response to the received request.

10. The network platform of claim 7, wherein the execution of the one or more sequences of instructions by the processor further causes the processor to determine whether the requesting user owns the other online application and when it is determined that the user does not already own the other online application, providing the user the opportunity to purchase the other online application.

11. The network platform of claim 7, wherein the execution of the one or more sequences of instructions by the processor further causes the processor to determine whether the requesting user owns the other online application and when it is determined that the user does not already own the other online application, opting the user into the other online application.

12. The network platform of claim 1, wherein execution of the one or more instructions defined by the online operating system cause the processor to:
receive a request to purchase the third party online application via the mobile desktop;
detect a billing event generated by the network-enabled application in response to the request to purchase the third party online application, wherein the billing event includes an identification code corresponding to a user;
perform a billing validation step in order to validate the billing event;
send a billing message from the network platform to an external billing mechanism via the plurality of communication channels, the billing message including a billing amount that the billing mechanism bills to the user.
